(19) United States
(12) Patent Application Publication
(10) Pub. No.: US 2025/0102448 A1
(43) Pub. Date: Mar. 27, 2025

(54) ULTRABROADBAND PHOTOCONDUCTION METHOD AND APPARATUS FOR DEFECT DENSITY OF STATES MICROSCOPY IN SEMICONDUCTOR DEVICES

(71) Applicant: Oregon State University, Corvallis, OR (US)

(72) Inventors: Kyle Timothy Vogt, Corvallis, OR (US); Maans Mattsson, Corvallis, OR (US); Matthew W. Graham, Corvallis, OR (US)

(73) Assignee: Oregon State University, Corvallis, OR (US)

(21) Appl. No.: 18/885,410

(22) Filed: Sep. 13, 2024

Related U.S. Application Data
(60) Provisional application No. 63/584,847, filed on Sep. 22, 2023.

(51) Int. Cl. G01N 21/95; G02B 21/00

(52) U.S. Cl. CPC G01N 21/9501; G02B 21/0016; G02B 21/0032; G02B 21/0052; G01N 2201/06113; G01N 2201/068

(57) ABSTRACT

Described is an apparatus and ultrabroadband photoconduction microscopy method for measuring full sub-bandgap density of defect states in semiconductor transistors and devices. The apparatus comprises tunable laser coupled to a reflective-optic-based microscope using all-reflective optical laser to spectrally and spatially illuminate near the diffraction-limit. The method developed measures the photoconduction signal in semiconductor devices at stepwise incident energies that roughly span the full bandgap from the valence band to the conduction band edge regions. The resulting photoconduction spectrum is directly proportional to the integrated trap density by an analytically extracted scaling factor. Finally, the end-product is a complete sub-gap density of states for a semiconductor device. As the sub-gap trap density drops exponentially when the laser wavelength increases, specialized signal retrieval methods, including lock-in amplifier detection of optically modulated lasers, power normalization, and threshold voltage monitoring, are required to achieve the signal-to-noise and accuracy needed.

### CLAIM OF PRIORITY

This application claims priority to U.S. Provisional Patent Application No. 63/584,847, filed on Sep. 22, 2023, titled “ULTRABROADBAND PHOTOCONDUCTION METHOD AND APPARATUS FOR DEFECT DENSITY OF STATES MICROSCOPY IN SEMICONDUCTOR DEVICES,” which is incorporated by reference in its entirety for all purposes.

### BACKGROUND

Defect density of states microscopy can be implemented in a wide variety of semiconductor device architectures and transistor materials. Defects, traps, and vacancy center concentrations in the active channel materials of transistors are typically critical to transistor functionality and their performance. To inform the development of high-performance transistors, measuring the defect density of states provides both the concentration of and energy of defect states distributed over the material bandgap.

### BRIEF DESCRIPTION OF THE DRAWINGS

Material described herein is illustrated by way of example and not by way of limitation in accompanying figures. For simplicity and clarity of illustration, elements illustrated in figures are not necessarily drawn to scale. For example, the dimensions of some elements may be exaggerated relative to other elements for clarity. Also, various physical features may be represented in their simplified “ideal” forms and geometries for clarity of discussion, but it is nevertheless to be understood that practical implementations may approximate illustrated ideals. For example, smooth surfaces and square intersections may be drawn in disregard of finite roughness, corner-rounding, and imperfect angular intersections characteristic of structures formed by nanofabrication techniques. Further, where considered appropriate, reference labels have been repeated among figures to indicate corresponding or analogous elements.

FIG. 1A illustrates an apparatus for performing defect density microscopy in semiconductor devices, in accordance with at least one embodiment.

FIG. 1B illustrates a schematic of tunable lasers implemented in the apparatus shown in FIG. 1A, in accordance with at least one embodiment.

FIG. 2 illustrates a method of implementing an apparatus for performing defect density microscopy to obtain experimental sub-bandgap defect density of states in a transistor channel, in accordance with at least one embodiment.

FIG. 3A illustrates a schematic of a transistor placed on a stage for initiating operation of microscopy, in accordance with at least one embodiment.

FIG. 3B illustrates a schematic of a back channel thin film transistor, in accordance with at least one embodiment.

FIG. 3C illustrates a plot of a current voltage trace of the thin film transistor described in FIG. 3B, in accordance with at least one embodiment.

FIG. 4 illustrates a schematic of setup for energizing a back gated thin film transistor (TFT) after being placed on a stage of the microscope, in accordance with at least one embodiment.

FIG. 5A illustrates a schematic of an energy level diagram showing trapped electron e in a sub gap state formed in a transistor channel due to oxygen vacancy defects, in accordance with at least one embodiment.

FIG. 5B illustrates a schematic of an energy level diagram illustrating photoexcitation of trapped electron e⁻ from an electron sub gap state formed in a transistor channel due to oxygen vacancy defects, in accordance with at least one embodiment.

FIG. 6 illustrates a plot of a current voltage trace of the TFT described in FIG. 4 following a process to direct a laser beam on a channel of the TFT, in accordance with at least one embodiment.

FIG. 7A illustrates a schematic of a plot of total current signal versus time for a laser beam scan at a representative energy value, prior to lock-in amplification, in accordance with at least one embodiment.

FIG. 7B illustrates a schematic of a plot of total current signal versus time for a laser beam scan at a representative energy value, post lock-in amplification, in accordance with at least one embodiment.

FIG. 8A illustrates a schematic illustrating performance of scan of a surface of the channel of the TFT, in accordance with at least one embodiment.

FIG. 8B illustrates a plot of photoconduction versus laser position on TFT channel at a given laser energy, within the ultrabroadband photoconduction energy spectrum, in accordance with at least one embodiment.

FIG. 8C illustrates a photoconduction map and an optical map of a portion of the TFT channel, in accordance with at least one embodiment.

FIG. 9 illustrates a plot of total integrated subgap trap density (N_{Tot}) of an amorphous channel material of the TFT as measured by ultrabroadband photoconduction, in accordance with at least one embodiment.

FIG. 10 illustrates a plot of defect density of states overlapped with total integrated subgap trap density (N_{Tot}) as illustrated in FIG. 9, in accordance with at least one embodiment.

FIG. 11 illustrates a plot of a gate voltage transfer curve for a tin oxide (SnO) TFT that exhibits ambipolar behavior, in accordance with at least one embodiment.

FIG. 12 illustrates a plot of representative ultrabroadband photoconduction (UBPC) measurements of an ambipolar stannous oxide (SnO) TFT, showing two separate sub-bandgap density of states (DoS) measurements derived from the UBPC measurements are plotted with respect to the valence and conduction band edges of the SnO TFT, in accordance with at least one embodiment.

FIG. 13 illustrates a plot of representative UBPC measurements for DoS of various semiconductor materials, including p-type SnO and Cu₂O, Si and n-type WSe₂, in accordance with at least one embodiment.

FIG. 14 illustrates a processor system with a machine-readable storage medium, in accordance with at least one embodiment.

### DETAILED DESCRIPTION

At least one embodiment describes an apparatus and a method of performing scanning ultrabroadband photoconduction (UBPC) microscopy to map positionally and spectrally sub-bandgap density of states (DoS) in semiconductor devices. Here, ultrabroadband may generally refer to an energy range between 0.06-3.2 eV. While at least one embodiment is described with reference to application to transistors, apparatus and methods described herein can be used for other applications where defects in semiconductor device are to be measured. In at least one embodiment, an apparatus and method for performing ultrabroadband photoconduction microscopy (UBPCM) is described with respect to a back-gated InGaZnOₓ (IGZO) channel of a thin film transistor (TFT).

Here, numerous specific details are set forth, such as structural schemes and detailed fabrication methods to provide a thorough understanding of embodiments of present disclosure. It will be apparent to one skilled in art that embodiments of the present disclosure may be practiced without these specific details. In other instances, well-known features, such as process equipment and device operations, are described in lesser detail to not unnecessarily obscure embodiments of present disclosure. Furthermore, it is to be understood that embodiments shown in Figures are illustrative representations and are not necessarily drawn to scale.

Note that in corresponding drawings of embodiments, optical traces and electrical signals are represented with lines. Some lines may be thicker, to indicate more constituent signal paths, and/or have arrows at one or more ends, to indicate primary information flow direction. Such indications are not intended to be limiting. Rather, lines are used in connection with one or more exemplary embodiments to facilitate easier understanding of optical systems, or circuits. Any represented optical trace or electrical signal, as dictated by design needs or preferences, may actually comprise one or more signals that may travel in either direction, and may be implemented with any suitable type of signal scheme.

Embodiments of disclosure will be understood more fully from detailed description given below and from accompanying drawings of various embodiments of disclosure, which, however, should not be taken to limit disclosure to specific embodiments, but are for explanation and understanding only.

Defects in semiconductor devices are known to degrade electrical and optical properties of semiconductor devices. In at least one embodiment, defects can take form of lattice dislocations, point defects, or vacancies. In semiconductors with amorphous materials, defects can be site vacancies. For example, a vacancy defect can be a removed neutral oxygen or a metal atom, V_{O} or V_{M}, respectively. In at least one embodiment, vacancies can be in an amorphous material implemented as a channel in a thin film transistor (TFT). In at least one embodiment, vacancy sites and other defects in active channel can control operation, doping, and reliability of transistors. Defects can affect the performance of TFT by introducing electronic levels into a bandgap of channel material. In many emerging transistors and solar materials, vacancy composition can result from growth methods utilized. Therefore, understanding the nature of, concentration, and distribution of defects can be a useful first step in fabricating devices that have widespread applications.

Amorphous oxide-based TFTs can be used as driver components for active-matrix liquid crystal and organic light-emitting diode (LED) displays as pixel control circuits. In at least one embodiment, amorphous In—Ga—Zn—O (a-IGZO) is an alternative to amorphous silicon for manufacturing TFTs with high channel mobility and low leakage current enabling large-area display applications. In a-IGZO, subtle variations in composition or processing can create bandgap defect and vacancy states that can control both TFT semiconducting behavior and performance limitations. The ability to measure and identify the structural origins of these bandgap states is useful to understanding electrical behavior of a-IGZO or related metal oxide TFTs.

The disordered nature of amorphous oxide thin films such as a-IGZO makes measurements of bandgap trap density states challenging. Not only can the density of bandgap states be small (e.g., less than 10¹⁶ cm⁻³), but threshold voltages of TFT transistors tend to drift during operation, making sensitive transport and photoconductive measurements challenging.

Earlier techniques such as photo-excited charge collection spectroscopy (PECCS) and photoluminescence (PL) spectroscopy can also be utilized to obtain spatial mapping of locations of intra-bandgap defect states. PL spectroscopy utilizes spectral photoemission systems that can obtain spatially-resolved point-by-point photoemission spectra by means of a diffraction grating placed in optical path of a photoemission microscope. PECCS employs conversion of transistor photocurrent spectrum (e.g., as a function of light energy) to derive a defect density of states (DoS). PECCS can have a limited scan range, having wavelength coverage limited to visible energies, as well as having a poor signal to noise ratio, making it challenging to examine defects in a semiconductor sample. Another method utilized to measure density of states is spatial confocal scanning photocurrent microscopy (SPCM), which uses refractive lenses in optics system, introducing wavelength dispersion.

In at least one embodiment, scanning ultrabroadband photoconduction (UBPC) microscopy avoids limitations of related methods PECCS and SPCM by employing solely reflective optics and extension of the lower end of the spectral range to 0.06 eV (20,000 nm) by combining tunable laser lines with a system of nonlinear optics including an optical parametric oscillator, a difference frequency generation crystal and a second harmonic generation crystal. UBPC can provide an on-chip or whole wafer method that enables a user to obtain spatial mapping of local densities of defect states within bandgap of a semiconductor device by scanning a focused laser light beam over a surface of the device such as a MOSFET TFT channel.

TFT behavior under illumination may depend strongly on photon energy (hν), especially upon photoexcitation of “deep states” near valence band, which suggests existence of multiple species of bandgap states. Near-bandgap photoexcited TFT behavior may be attributed to defects related to hydrogen, excess oxygen, and lack of oxygen. The existence of cation vacancy (V_{M})-related clusters in IGZO may be used as a vehicle for inclusion of stable excess oxygen. Currently, there is ambiguity about the exact structural origin of bandgap states.

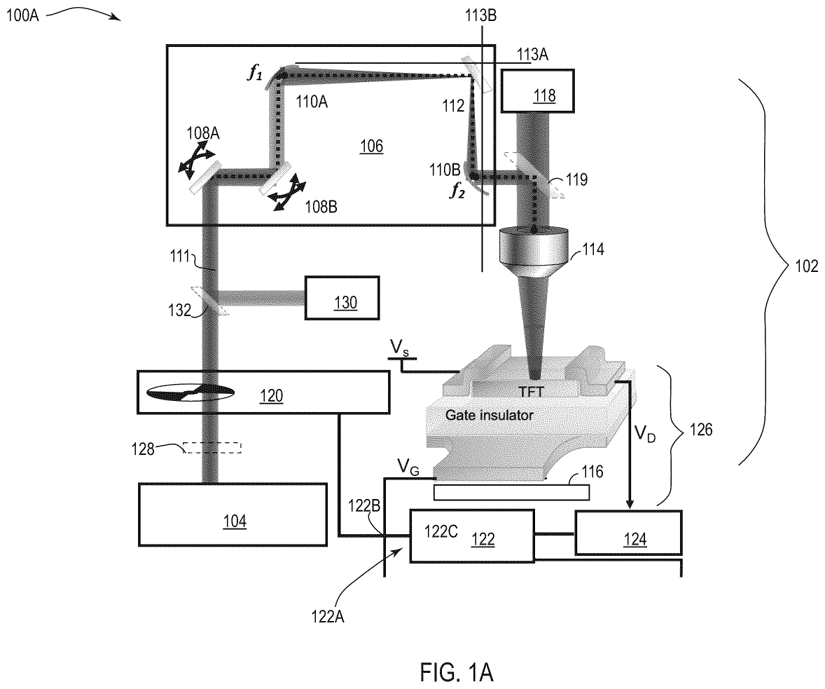

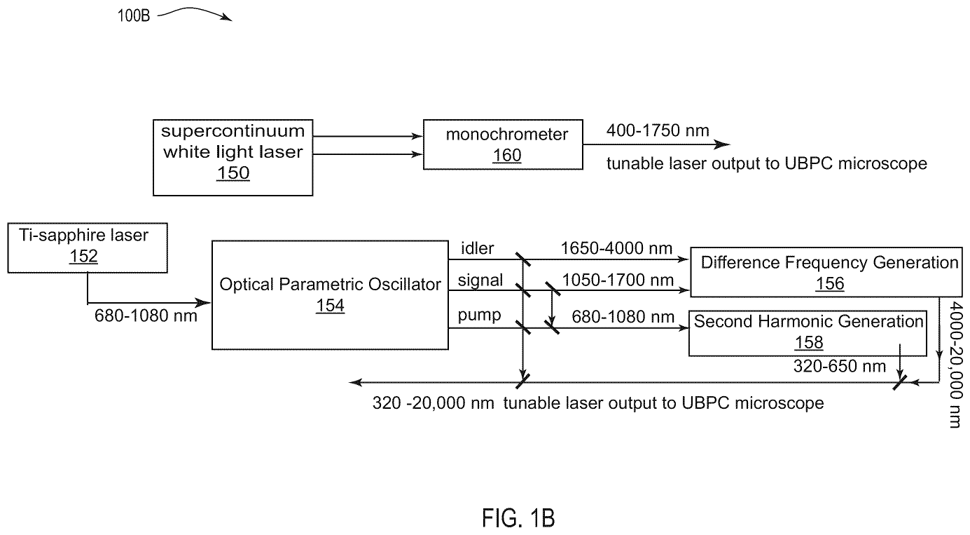

FIG. 1A illustrates a scanning UBPC microscopy apparatus 100A comprising microscope 102, tunable laser system 104, an all-reflective optical path laser scanning system 106 coupled between microscope 102 and tunable laser system 104, in accordance with at least one embodiment. In at least one embodiment, microscope 102 may include an optical microscope, having a unitary body, sample stage, and focusing objective combined into a single apparatus (e.g., a laboratory optical microscope). In at least one embodiment, microscope 102 may comprise stand-alone components, such as a separate focusing objective and sample stage, whereby a unitary body combining the components is omitted. In at least one embodiment, scanning UBPC microscopy apparatus 100A can be utilized to determine density of state of channel material in a semiconductor device. In at least one embodiment, all-reflective optical path laser scanning system 106 is an example of an f/4 confocal scanning geometry, that utilizes principles of light reflection to direct a laser beam. In at least one embodiment, all-reflective optical path laser scanning system 106 comprises a plurality of piezo scanning mirrors (such as mirror 108A, and scanning mirror 108B), parabolic reflector 110A, and parabolic reflector 110B. In at least one embodiment, all-reflective optical path laser scanning system 106 further includes at least one stationary mirror 112 optically between parabolic reflector 110A and parabolic reflector 110B.

In some embodiments, a 4f-confocal geometry system, parabolic reflector 110A, and stationary mirror 112 are positioned on a plane 113A. Here, 4f (f/4) refers to the 4-focal length distances (between the piezo scanning mirror and objective back-plane) that are matched to achieve near diffraction-limited laser scanning. This 4f standard condition is met by correct focal length choice of the parabolic reflector 110B, for example, comprising off-axis parabolic reflecting mirrors, to match distance covered and achieve laser beam collimation. In at least one embodiment, parabolic reflector 110B and stationary mirror 112 are positioned on a plane 113B, where plane 113A and plane 113B are orthogonal to each other.

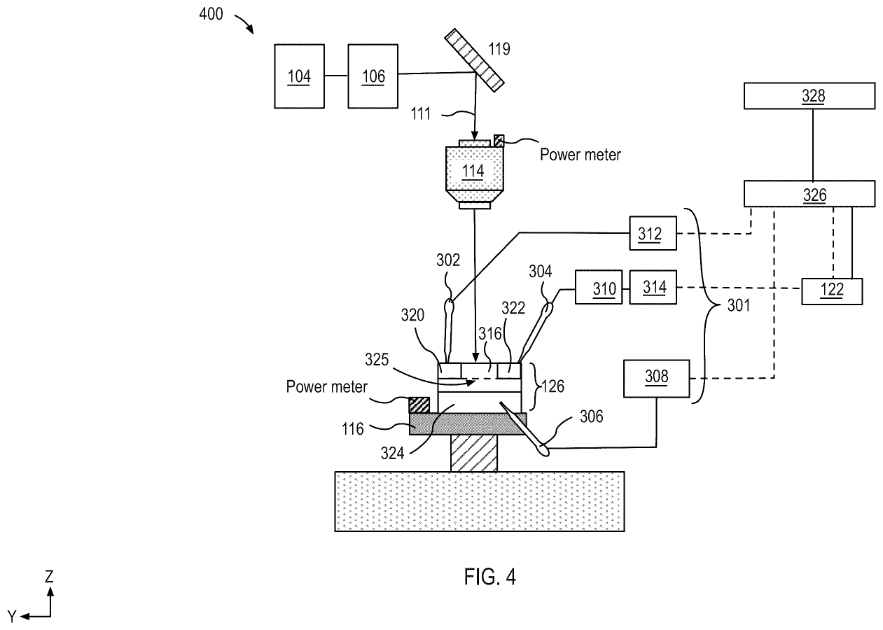

In at least one embodiment, mirror 108A, and scanning mirror 108B are designed to be rotated or tilted. In at least one embodiment, rotation of mirror 108A and mirror 108B can be coupled or independent of each other. In at least one embodiment, rotation is designed to bring about a change in an angle of incidence of laser light 111 at parabolic reflector 110A, and consequently at stationary mirror 112, at parabolic reflector 110B, and at mirror 119, which is external to reflective laser scanning system 106. In at least one embodiment, rotation of mirror 108A, and scanning mirror 108B can be utilized to raster laser light 111. In at least one embodiment, utilization of reflective mirrors in all-reflective optical path laser scanning system 106 is useful in reducing spectral aberrations. In at least one embodiment, microscope 102 comprises an optical sensor (shown in FIG. 4) for measuring the optical power of an impinging laser beam.

FIG. 1B is a schematic 100B of tunable lasers implemented in scanning UBPC microscopy apparatus 100A in FIG. 1A, in accordance with at least one embodiment. In at least one embodiment, tunable laser system 104 in FIG. 1A is a laser system comprising a Ti-sapphire tunable laser 152 (e.g., a Coherent Chameleon Ultra II Ti-sapphire laser) and a supercontinuum white light (SCWL) laser 150 (e.g., a Fianium SC 400 high-power fiber supercontinuum laser) operating in tandem. Ti-sapphire laser 152 may have a continuously tunable output ranging between 680 nm and 1080 nm. In at least one embodiment, Ti-sapphire laser 152 and SCWL laser 150 have high Poynting vector stability to enable high stability of the laser beam impinging on the TFT. In at least one embodiment, the required laser Poynting vector stability condition (over the 320 to 10,000 nm scan range) is simplified by coupling some of the laser lines shown in FIG. 1B into single-mode fiber optical patch cables. The exiting laser (e.g., Ti-sapphire laser 152 and/or SCWL laser 150) is then recollimated using all-mirror based off-axis parabolic mirrors that match the numerical aperture (NA) of the optical fiber. The lasers are then coupled into the UBPC microscope apparatus 100A shown in FIG. 1A, with improved Poynting vector stability on the semiconductor device under measurement.

In at least one embodiment, Ti-sapphire laser 152 may be coupled to a non-linear optical system comprising optical parametric oscillator (OPO) 154, difference frequency generation (DFG) crystal 156, and second-harmonic generation (SHG) crystal 158.

While at least one embodiment makes use of Ti-sapphire laser 152, it may be understood that a Ti-sapphire laser is exemplary, and that other types of tunable lasers may be employed without departing from spirit or scope of disclosed apparatus. In at least one embodiment, an exemplary Ti-sapphire laser 152 may have a maximum femtosecond-pulsed output of 4 watts optical power within a 20 nm full-width half maximum (FWHM) bandwidth over a 140-femtosecond pulse-width.

In at least one embodiment, the microscope is coupled to a tunable laser system 104 and scans the laser in a ‘hands-free’ tunable fashion by using a Ti-Sapphire laser coupled with an optical parametric oscillator to provide a spectral scanning range between 0.31 eV between 3.9 eV or a wavelength between 320 nm and 4000 nm.

In at least one embodiment, tunable laser system 104 is designed to operate over the broadest wavelength range between 320 nm and 20,000 nm (or equivalently and energy range of 0.12 eV to 3.9 eV) by coupling the microscope to multiple, stepwise tunable laser lines. The ultrabroadband spectral range 320 nm to 20,000 nm output range of tunable laser system 104 may be created by combining five generated laser lines in the following manner, as shown in FIG. 1B. In at least one embodiment, tunable output (e.g., 680 nm to 1080 nm) of Ti-Sapphire laser 152 is coupled to optical parametric oscillator (OPO) 154, which outputs three laser lines. The three laser lines comprise the idler, signal, and pump OPO spectral lines. Each OPO spectral line may have a wavelength range as shown in FIG. 1B. In at least one embodiment, two spectral lines from OPO 154 (e.g., idler and signal lines) are coupled to difference frequency generation crystal 156, providing a spectral output ranging between approximately 4000 nm and 20,000 nm (0.06 eV and 0.3 eV). The laser-based apparatus enables an equivalent energy coverage of approximately 0.06 eV to 3.90 eV, sufficient to span the energy range of all subgap defect states for most materials.

In at least one embodiment, the third line (pump) output line of OPO 154 is coupled to second-harmonic generation crystal 156, providing a spectral output ranging between approximately 340 nm and 650 nm (1.9 eV and 3.9 eV). In at least one embodiment, tunable laser system 104 comprises supercontinuum white light (SCWL) laser 150 working in tandem with Ti-sapphire laser 152. In at least one embodiment, SCWL laser 150 outputs two spectral lines, as shown in FIG. 1B. The two spectral line output from SCWL laser 150 may be coupled to monochromator 160, which outputs a continuous 400 nm to 1700 nm range (0.73 eV to 3.1 eV range).

In at least one embodiment, the spectral inputs and outputs of the nonlinear optical components of laser system 104 may be routed and combined as shown in FIG. 1B by use of beam splitters and combiners. In at least one embodiment, the combination of the various spectral lines shown in FIG. 1B is operable to produce a continuously tunable ultrabroadband spectral range of 320 nm to 20,000 nm.

Referring again to FIG. 1A, in at least one embodiment, microscope 102 further includes reflective objective 114, stage 116, and charge-coupled device (CCD) 118. In at least one embodiment, reflective objective 114 and stage 116 may be stand-alone components, not necessarily incorporated within the body of an optical microscope. In at least one embodiment, scanning UBPC microscopy apparatus 100A further comprises optical modulator 120 between system 104 and all-reflective optical path laser scanning system 106. In at least one embodiment, all-reflective optical path laser scanning system 106 comprises an all-reflective optical path where refractive optical components, such as lenses, are omitted. Employment of all-reflective optical components such as parabolic mirrors mitigate or eliminate chromatic aberration, etc. Coupling an all-reflective optical path between tunable laser system 104 and reflective objective 114 enables formation of sub-50 micron-sized laser spots that may be down to diffraction-limited dimensions on a focal plane comprising a semiconductor device (e.g., a channel region of a MOSFET TFT) by focusing an aberration-free laser beam through reflective objective 114. In at least one embodiment, reflective objective 114 is an infinity-corrected reflective microscope objective (or reflective-based microscope objective). In at least one embodiment, reflective objective 114 has a magnification of at least 50×.

In at least one embodiment, scanning UBPC microscopy apparatus 100A further comprises lock-in amplifier 122 for signal processing. In at least one embodiment, optical modulator 120 is coupled with input 122A (e.g., a reference input) of lock-in amplifier 122. In at least one embodiment, scanning UBPC microscopy apparatus 100A further comprises current preamplifier 124 coupled between a semiconductor device 126 (e.g., at a drain terminal of a MOSFET) and input 122B of lock-in amplifier 122. In at least one embodiment, current preamplifier 124 is also coupled to an oscilloscope (not shown) to extract rise and fall times corresponding to defect-specific recombination lifetimes. The recombination lifetimes may be obtained by scanning the spectral photon energy output of tunable laser system 104 and measuring carrier lifetimes obtained from time constants derived from exponential current decay curves captured by the oscilloscope. In at least one embodiment, scanning UBPC microscopy apparatus 100A further includes variable attenuator 128 between tunable laser system 104 and optical modulator 120. In at least one embodiment, scanning UBPC microscopy apparatus 100A further comprises photodetector 130 coupled with input 122C of lock-in amplifier 122. In at least one embodiment, photodetector 130 is optically coupled to beam splitter 132 that is between mirror 108A and optical modulator 120.

As shown in FIG. 1A, laser light 111 may be modulated by optical modulator 120 to enable discrimination of photocurrent from dark current by lock-in amplifier 122. In at least one embodiment, optical modulator 120 can be a mechanical light chopper. In at least one embodiment, lock-in amplifier 122 is designed to eliminate contribution of dark current background and hysteretic drift, by referencing frequency of lock-in amplifier 122 to frequency of operation of optical modulator 120. In at least one embodiment, optical modulator 120 is designed to operate at frequencies between 200 Hz and 1 kHz. In at least one embodiment, optical modulator 120 is designed to operate at a frequency of 585 Hz.

In at least one such embodiment, a portion of laser light 111 that is chopped by optical modulator 120 may be directed to photodetector 130 by beam splitter 132. In at least one embodiment, photodetector 130 can comprise a photodiode or phototransistor, that converts impinging laser light 111 to a square wave or quasi-square wave voltage signal. In at least one embodiment, quasi-square wave voltage signal can vary in time and phase with laser light 111 that is modulated. In at least one embodiment, voltage output of photodetector 130 may be fed to a reference signal input (number) of lock-in amplifier 122.

In at least one embodiment, current preamplifier 124 is designed to amplify current signal from a terminal of semiconductor device 126 to be examined. In at least one embodiment, a total current output, comprising dark current and photocurrent from semiconductor device 126 may pass through current preamplifier 124 prior to being input into lock-in amplifier 122. In at least one embodiment, current preamplifier 124 may convert total current output to a voltage waveform that follows shape of total current output. In at least one embodiment, lock-in amplifier 122 may receive voltage signal from output of current preamplifier 124 at a signal channel.

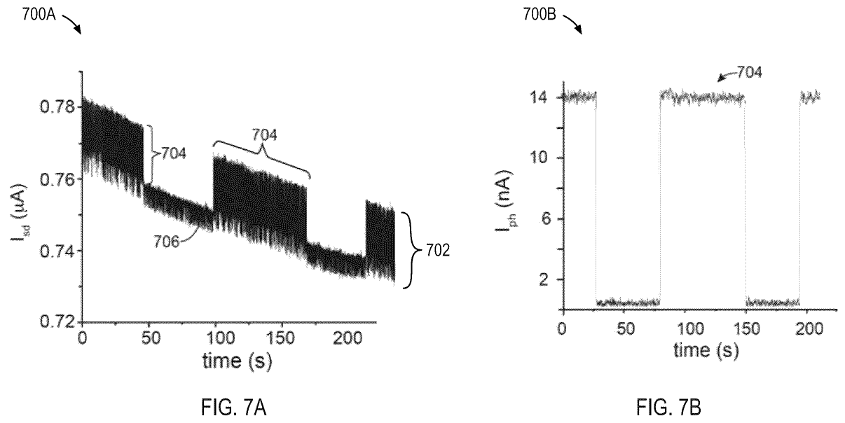

In at least one embodiment, photocurrent component of total current signal (e.g., 0 to 20 nanoamperes, nA) may be a small fluctuation superimposed on a significantly larger dark background (e.g., 500 nA to 1000 nA). In at least one embodiment, a phase-lock circuitry within lock-in amplifier 122 may lock onto relatively small photocurrent as it is substantially in phase and has substantially same frequency as a reference signal from photodetector 130, discriminating a small photocurrent from much larger dark current background. In at least one embodiment, lock-in amplifier 122 may output a voltage signal that represents photocurrent component (e.g., see FIG. 7A and FIG. 7B).

In at least one embodiment, photodetector 130 is utilized to follow and monitor intensity of laser light 111. In at least one embodiment, fluctuations of laser intensity can be input into lock-in amplifier 122, tracked and subtracted from fluctuations in photocurrent signal obtained from current preamplifier 124.

In at least one embodiment, drifts in laser light 111 intensity may also be detected and corrected by lock-in amplifier 122 by tracking the amplitude of laser light 111 signal that is modulated, as will be discussed below. In at least one embodiment, further processing may include subtracting out any light drift component from amplitude of photocurrent, as photocurrent is proportional to illumination power intensity. In at least one embodiment, fluctuations in amplitude of photocurrent are directly proportional to density of intra-bandgap states. In at least one embodiment, a larger density of states of an intra-bandgap energy level or band may contribute more photoexcited trapped charge to conduction band, than an energy level having a smaller density of states. Promotion of charges (e.g., electrons) trapped in occupied intra-bandgap states, such as shallow and deep donor states, and/or acceptor states, into conduction (or holes into valence band of a p-type material) may momentarily increase total current by contributing photoexcited carriers to generate a photocurrent, as formerly trapped charges become conduction carriers (e.g., electrons or holes).

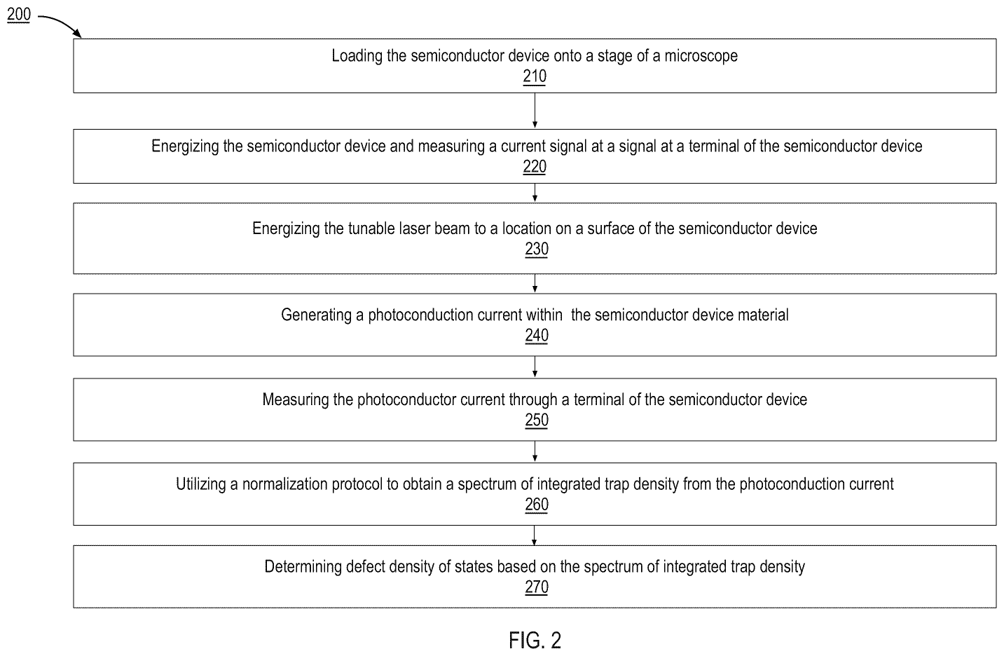

FIG. 2 illustrates method 200 of determining defect density of states in a channel of a semiconductor device by scanning UBPC microscopy, in at least one embodiment. In at least one embodiment, method 200 begins at operation 210 by loading semiconductor device onto a stage of an apparatus, such as scanning UBPC microscopy apparatus 100A (FIG. 1A). In at least one embodiment, method 200 continues at operation 220 by energizing the semiconductor device and measuring a current signal at a terminal of semiconductor device. In at least one embodiment, method 200 continues at operation 230 by energizing tunable laser and directing a laser beam to a location on a surface of semiconductor device. In at least one embodiment, method 200 continues at operation 240 by generating a photoconduction current within semiconductor device by energizing tunable laser and shining emitted laser light onto a region of semiconductor device (e.g., onto thin film channel region of a TFT) under test.

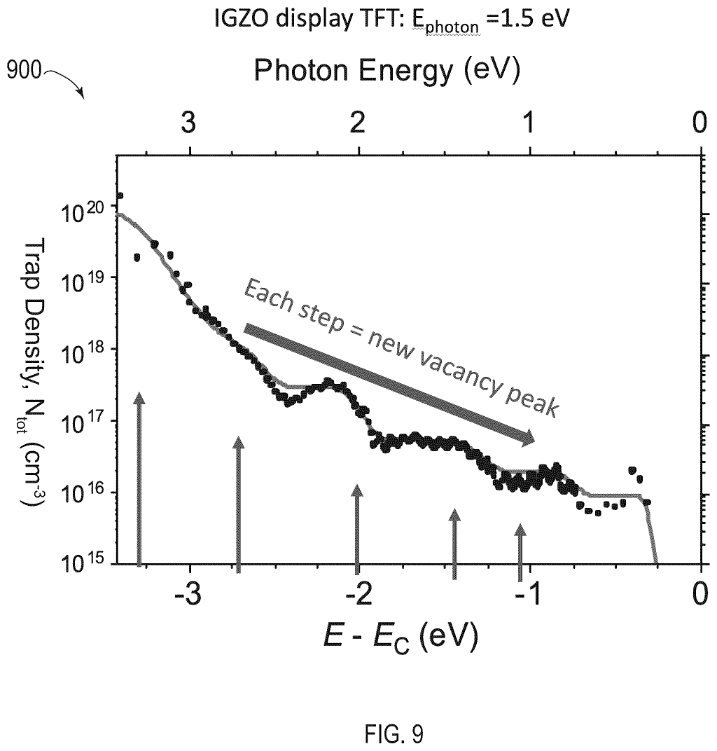

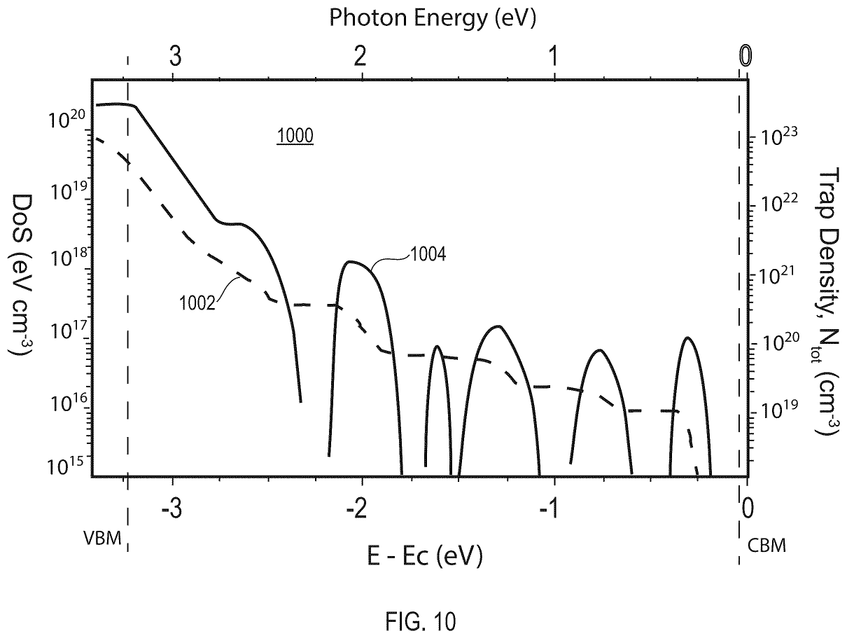

In at least one embodiment, method 200 continues at operation 250 by measuring total current Iₜₒₜ flowing through a terminal of semiconductor device. In at least one embodiment, Iₜₒₜ is sum of a photocurrent Iₚₕ 704 superimposed on a dark current I_{dark} 706. In at least one embodiment, I_{dark} 706 is source-to-drain current I_{SD} of a TFT. In at least one embodiment, method 200 continues at operation 260 by performing a numerical normalization protocol to obtain a spectrum of integrated defect (e.g., trap) density from a raw photocurrent (Iₚₕ) spectrum (e.g., see FIG. 9 and FIG. 10). In at least one embodiment, trap density is computed by normalizing photocurrent spectrum by photon flux or intensity at leach wavelength. In at least one embodiment, photon flux is measured by a power meter chip that may be adjacent to semiconductor device under test. In at least one embodiment, method 200 ends at operation 270 by computing a density of intra-bandgap states (DoS) by numerically differentiating trap density spectrum.

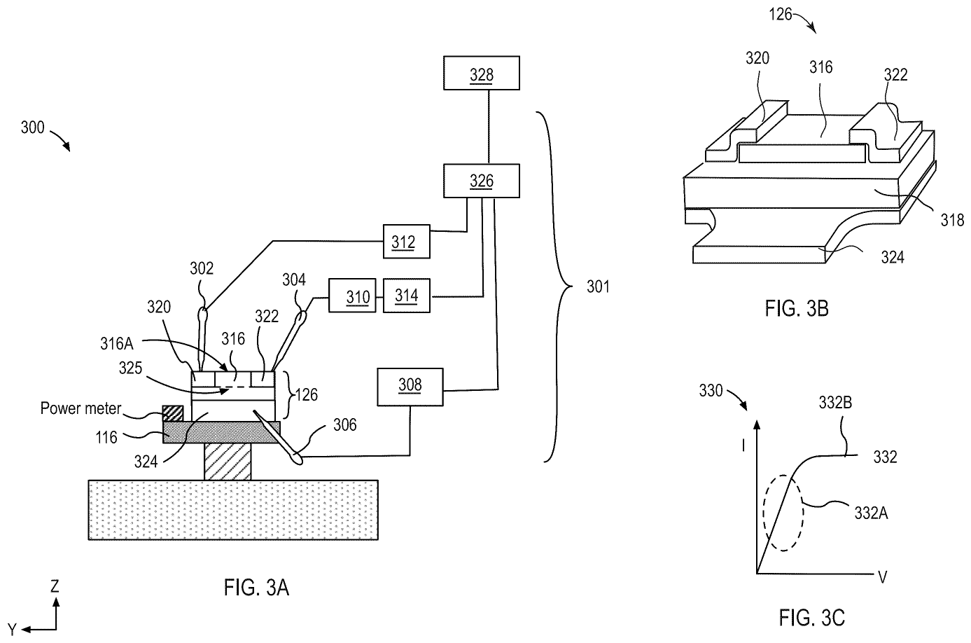

FIG. 3A is a schematic 300 depicting operation 220 (FIG. 2) where semiconductor device 126 is placed on stage 116 for determining defect density of states (DoS), in accordance with at least one embodiment. Referring collectively to FIGS. 1, 2, and 3A, in at least one embodiment, operation 220 comprises loading semiconductor device 126 onto stage 116 of scanning UBPC microscopy apparatus 100A. In at least one embodiment, semiconductor device 126 is a thin-film MOSFET transistor (TFT). In at least one embodiment, a probe station 301 includes probe 302, probe 304, and probe 306, that contact, respectively, source 320, drain 322, and gate electrode 324 of semiconductor device 126. In at least one embodiment, probes 302-306 are designed for radio frequency (RF) service.

An exemplary MOSFET TFT is shown in FIG. 3B, in accordance with at least one embodiment. In at least one embodiment, semiconductor device 126 includes channel 316, source 320, and drain 322, and gate dielectric 318 between gate electrode 324 and channel 316. In at least one embodiment, gate dielectric 318 may comprise a metal oxide or metalloid oxide layer adjacent to surface of channel 316, as shown, forming a dielectric/semiconductor interface with channel 316. In at least one embodiment, semiconductor device 126 is an example of a back-gated device.

In at least one embodiment, channel 316 comprises semiconductive materials amenable to thin film fabrication, group IV materials such as silicon, germanium, and silicon-germanium; III-V compounds such as gallium arsenide, gallium phosphide, gallium nitride, indium phosphide, indium arsenide; and II-VI compounds such as tungsten sulfide and selenide and molybdenum sulfide and selenide. In at least one embodiment, channel 316 comprises semiconductive oxide materials of multiple systems, such as simple transition metal oxides (e.g., zinc oxide, titanium dioxide, iron oxide, etc.) and combined transition metal-non-transition metal oxide materials such as indium gallium zinc oxide (IGZO).

In at least one embodiment, IGZO TFTs are used as an example of semiconductor device 126. In at least one embodiment, semiconductor device 126 may also be a member of other classes of electronic device, such as group III-V, II-VI and VI non-oxide CMOS transistors, p-n junction, Schottky diodes, and voltage-controlled capacitors, etc., whose electronic characteristics include intra-bandgap states.

In at least one embodiment, based on fabrication technique, material quality, types of impurities, and concentration of impurity, channel 316 of a semiconductor device 126 may have a high density of defects such as dislocations, vacancies, impurities, grain boundaries, etc. In at least one embodiment, such physical defects may introduce a density of intra-bandgap states in channel 316. In at least one embodiment, channel 316 may comprise a thin film (e.g., thickness of 100 nm), integrity of which, such as disorder, may depend on deposition conditions, substrate preparation, etch treatments, etc. Defects may be readily induced within channel 316 during fabrication. In at least one embodiment, defect states are electronic energy levels produced by filled or unfilled electron orbitals of defect (e.g., an atomic vacancy or other defect that may locally disorder a crystalline or amorphous lattice) not aligned with ordered structure of atomic or molecular orbitals of host material. In at least one embodiment, in a defect-free pure material, intra-gap states may be non-existent because all orbitals of atoms or molecules within crystalline or amorphous solid material are energetically aligned within valence band or conduction band structures.

Referring again to FIG. 3A, in at least one embodiment, probe 306 is electrically coupled to bias voltage source 308, providing active bias to gate electrode 324 of semiconductor device 126. In at least one embodiment, probe 304 is electrically coupled to bias voltage source 310, providing active bias to drain 322 of semiconductor device 126. In at least one embodiment, source 320 of semiconductor device 126 may be held at ground potential by probe 306, that is coupled to voltage source 312. In at least one embodiment, voltage source 308 and voltage source 312 may be combined within a single unit, respectively, providing active bias to gate electrode 324 relative to source 320. In at least one embodiment, a gate bias voltage Vos may be applied between gate electrode 324 and source 320.

In at least one embodiment, probes 302-306 may be magnetically mounted in the opposite optical plane (i.e., upside-down) to reflective objective 114 (shown in FIG. 1A). This geometry may be employed for studying semiconductor devices with top-gate geometries where electrical contact and illumination often occurs on opposite sides. This alternative geometry enables silicon wafer devices that are otherwise opaque to light (from metal top-gates) to have their density of states (DoS) measured.

In at least one embodiment, voltage source 310 and voltage source 312 may be combined within a single unit. In at least one embodiment, voltage sources 310 and 312 may respectively provide active bias to drain relative to source 320. In at least one embodiment, voltage sources 310 and 312 may provide a voltage V_{DS} across channel 316, between drain 322 and source 320. In at least one embodiment, drain 322 is coupled to amp-meter 314 to measure the current flowing from drain 322. In at least one embodiment, voltage sources 308 and 310 may be biased to vary gate and drain voltages to enhance or deplete channel 316 of semiconductor device 126. In at least one embodiment, biasing of source 320, drain 322, and gate electrode 324 can be done by computer 326 through a computer interface 328. In at least one embodiment, computer interface 328 may comprise analog to digital and digital to analog data conversion systems to transmit signal to and from voltage and current sources.

In at least one embodiment, enhancement or depletion of channel 316 may be regulated by V_{GS} bias to respectively increase or decrease conductivity of channel 316. In at least one embodiment, V_{GS} bias may be regulated to increase or decrease source 320 to drain 322 current I_{DS} through channel 316. In at least one embodiment, semiconductor device 126 may be operated within the linear regime of an I_{SD} versus V_{DS} (at constant V_{GS}) transfer characteristic shown in FIG. 3C of semiconductor device 126. FIG. 3C shows I_{DS} as a function of V_{GS} plot 330 of the transfer characteristic 332, comprising linear portion 332A and saturation region (plateau portion 332B) as a plateau.

In at least one embodiment, semiconductor device 126 may be a depletion-enhancement (DE) type MOSFET or an enhancement-only type MOSFET. For a n-type channel DE-MOSFET, V_{GS} may be positive of a threshold voltage V_{T}, above which device is in enhancement mode, enabling a source-drain current I_{SD} to flow through channel 316. In at least one embodiment, V_{T}=0V with respect to ground potential. In at least one embodiment, when operated in a depletion mode (V_{GS}<V_{T}), source-drain current flow is decreased to zero. In at least one embodiment, enhancement mode operation may draw majority charge carriers (e.g., electrons) or minority carriers (e.g., holes) in the case of an enhancement-only device, to interface 325 between channel 316 and gate dielectric 318, whereas depletion mode operation repels majority charge carriers from interface 325 (gate dielectric 318 may be a gate oxide comprising silicon dioxide, for example).

In at least one embodiment, semiconductor device 126 may be an n-channel MOSFET or a p-channel MOSFET. In at least one embodiment, a positive gate bias for an n-channel MOSFET enhances channel 316 by attracting majority carriers (e.g., majority electrons), whereas same positive gate bias applied to a p-channel MOSFET places channel 316 in depletion mode by driving away majority holes from interface 325. In at least one embodiment, majority carriers may flow as dark channel current within channel 316 under the influence of voltage bias between source 320 and drain 322.

In at least one embodiment, enhancement mode may populate a conduction band or valence band of channel 316 with majority carriers (e.g., electrons or holes) for n-channel or p-channel devices, respectively. In at least one embodiment, at interface 325, Fermi level in bulk of channel 316 is driven above or below conduction or valence band, respectively. In at least one embodiment, high densities of intra-bandgap states may pin Fermi level, preventing or delaying full enhancement or depletion of channel 316. In at least one embodiment, pinning of Fermi level may cause anomalies, such as hysteresis, in (dark) I-V characteristic of semiconductor device 126. In at least one embodiment, the distribution of intra-bandgap states, and thus the effect of intra-bandgap states, may be non-uniform across channel 316. In at least one embodiment, non-uniform intra-bandgap state distributions can cause transfer characteristic anomalies in different portions of channel 316.

FIG. 4 is an illustration of apparatus 400 utilized to perform operation 230 (FIG. 2) where tunable laser system 104 may be energized after turning on the semiconductor device 126, in at least one embodiment. In at least one embodiment, detection of intra-bandgap states may be performed by energizing tunable laser system 104, where laser light 111 of tunable laser system 104 is directed to an x, y location on surface of semiconductor device 126 (e.g., within channel 316). In at least one embodiment, tunable laser system 104 comprises a tunable laser, such as titanium-sapphire laser 152 shown in FIG. 1B. The tunable laser may have a tunable output range between 650 nm and 1100 nm (spectral range for a Ti-sapphire laser; it is understood that other suitable tunable lasers having a desirable spectral output range may be employed). In at least one embodiment, tunable laser system 104 further comprises a system of nonlinear optical components such as an optical parametric oscillator (e.g., OPO 154 in FIG. 1B), a difference frequency generation crystal (e.g., DFG crystal 156), and a second-harmonic generation crystal (e.g., SHG crystal 158) to extend spectral output of the tunable laser (e.g., Ti-sapphire laser 152 shown in FIG. 1B) to an ultrabroadband spectral range of 320 nm to 20,000 nm. In at least one embodiment, tunable laser system 104 is operational to produce a usable tuning range between 0.06 eV and 3.9 eV, as described above. In at least one embodiment, tunable laser system 104 also comprises a supercontinuum white light laser (e.g., SCWL laser 150, FIG. 1B) producing an ultrabroadband spectral output of 0.7 eV to 3.1 eV. The supercontinuum white light laser is coupled to a monochromator (e.g., monochromator 160, FIG. 1B) to obtain tunable spectral resolution of its output.

In at least one embodiment, apparatus 400 incorporates substantially the entirety of scanning UBPC microscopy apparatus 100A shown in FIG. 1A. In at least one embodiment, apparatus 400 includes microscope 102, comprising reflective objective 114. Microscope 102 is also referred to as a reflective-based microscope comprising a reflective-based objective. In at least one embodiment, mirror 119 may direct laser light 111 into reflective objective 114, focusing laser beam to a microscopic spot (e.g., 1 μm to 10 μm diameter spot size, and/or down to diffraction-limited spot sizes) directed onto channel 316. In at least one embodiment, a solid-state illumination power meter or photosensor (labelled power meter in the figure) may be included at the objective entrance and/or adjacent to semiconductor device 126. Inclusion of such a power meter may enable measurements of illumination power or intensity of incoming laser light at each photon energy hν. A photon flux normalization may be included in numerical computation of a quantum efficiency Φ(hν) as a function of photon energy. The quantum efficiency Φ(hν) may be included in numerical computations of intragap trap density Nₜₒₜ(hν) (e.g., see Eq. (2) below and FIG. 9), which may be further numerically differentiated to obtain an intragap DoS (e.g., DoS=d(Nₜₒₜ(hν)/d(hν).

In at least one embodiment, laser light 111 may be held at a stationary position on back surface of channel 316, where back surface is opposite to interface 325. In at least one embodiment, laser light 111 may be monochromatic, comprising a narrow band of wavelengths (e.g., 20 nm) in a Gaussian envelope centered about a central wavelength. In at least one embodiment, wavelength of laser light 111 is tunable over a broad range that may cover near infrared, visible, and ultraviolet spectrum. In at least one embodiment, a tunable laser (e.g., tunable laser system 104) may be tuned to provide monochromatic light (with aid of external nonlinear optics such as a shown in FIG. 1B), over a range of approximately 0.06 eV to at least 3.9 eV.

In at least one embodiment, broad tunability range (e.g., a tuning range of 3.9 eV or greater) provided by tunable laser system 104 and associated non-linear optics is useful for probing intra-bandgap states throughout an entire bandgap of wide bandgap semiconductor materials. In at least one embodiment, channel 316 comprises a wide bandgap semiconductive material such as IGZO (E_{g}˜3.1 eV). In at least one embodiment, tuning of laser light 111 between spectral extremes (e.g., 0.06 eV to 3.9 eV) may enable scanning of energetic positions of intra-bandgap states across entire bandgap of wide bandgap material. In at least one embodiment, scanning with laser system having energy range 0.06 eV to 3.9 eV can lead to photoexcitation of charge carriers (e.g., electrons) trapped in shallow and deep intra-bandgap donor and/or acceptor states into conduction (or valence) band.

An extended spectral range between 0.06 eV to 0.3 eV afforded by disclosed UBPC microscope (e.g., UBPCM apparatus 100A) over earlier designs enables probing of shallow donor states close to conduction band edge, for example. Extreme photon energies of 3.9 eV enables probing of deep intra-bandgap states and states near valence band edge. For example, deep acceptor states residing near valence band edge may be probed in IGZO, or in other wide bandgap semiconductors. In at least one embodiment, where channel 316 includes a p-type material, Fermi level is near valence band edge. In this embodiment, the p-type material vacancy defect states in bandgap are predominately unoccupied, and so the photons (from laser light 111) instead promote valence band electrons into empty states, leading to enhanced photoconduction via the holes created in the valence band. After which, the same protocol is used to reconstruct the defect density of states for p-type transistors and semiconductor devices.

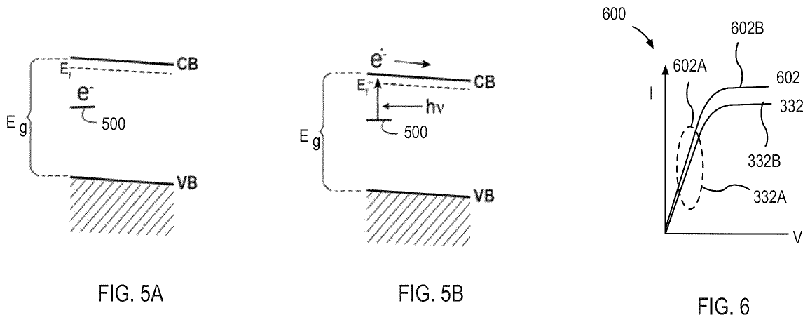

FIG. 5A and FIG. 5B illustrate a schematic of an electron photoexcitation process, where a majority charge carrier (electron e⁻) is trapped in an intra-bandgap state 500 of semiconductor device 126, in accordance with at least one embodiment. In at least one embodiment, semiconductive material is a-IGZO film within channel 316, having a bandgap width E_{g} of 3.1 eV. In at least one embodiment, intra-bandgap state 500 is at an energy hν eV below conduction band edge (labelled CB), Quantity h is Plank's constant and ν is frequency of laser light (hν is less than E_{g}). In at least one embodiment, intra-bandgap state 500 is occupied by a trapped electron e⁻ since Fermi level E_{F}, which is above intra-bandgap state 500, is mostly near conduction band edge.

In FIG. 5B, trapped electron e is photoexcited by a photon of energy hν eV, promoting electron to conduction band, in at least one embodiment. Once in conduction band, photoelectron may relax to lowest occupied energy level above or near conduction band edge by non-radiative processes. In at least one embodiment, photoelectron (indicated by asterisk) may drift under influence of an electric field set up across channel 316 by a bias voltage across channel 316 (e.g., source to drain bias or V_{DS}), creating a photocurrent. In at least one embodiment, band edges (CB and VB) are sloped to indicate presence of an applied electric field, driving photoelectron toward right in figure.

FIG. 6 illustrates plot 600 illustrating two I_{DS} versus V_{DS} transfer characteristics. Dark transfer characteristic 332 is depicted in plot 330 (FIG. 3C). Transfer characteristic 602 is a total current Iₜₒₜ measured during laser illumination. Iₜₒₜ is a sum of a photocurrent Iₚₕ 704 superimposed on dark current I_{dark} 706, reflecting measured photocurrent after laser light 111 strikes surface of channel 316. In at least one embodiment, transfer characteristic 602 has same shape as dark transfer characteristic 332 (e.g., a linear portion 332A and a plateau portion 332B) but is offset from dark transfer characteristic 332 by ΔI (e.g., several nanoamperes) due to presence of photoexcited majority charge carriers that have been promoted to conduction or valence bands by laser light 111 striking surface of channel 316. In at least one such embodiment, transfer characteristic 602 also has a linear portion 602A and a plateau region 602B. In at least one embodiment, linear portion 602A has an increased gradient compared to linear portion 332A due to superimposed photocurrent.

In at least one embodiment, semiconductor device 126 may be biased to operate within linear portion 332A, within a plateau portion 332B, or biased with a steadily stepped voltage during measurement of intra-gap DoS.

FIG. 7A illustrates plot 700A of total current signal 702 prior to lock-in amplification. In at least one embodiment, total current signal 702 comprises photocurrent from electron excitation, herein Iₚₕ 704. In at least one embodiment, total current signal 702 is sum of photocurrent Iₚₕ 704 superimposed on dark current baseline level I_{dark} 706. In at least one embodiment, I_{dark} 706 is characterized by gradual drift indicated as a baseline slope. In at least one embodiment, Iₚₕ 704 is modulated as a slow square waveform superimposed on sloping baseline of I_{dark} 706. To clearly illustrate Iₚₕ and I_{dark} 706, the time scale of square wave duty cycle (e.g., chop rate) is chosen to correspond to time scale of baseline drift, which is in order of minutes.

As noted above, total current signal 702 displayed in plot 700A may be characterized by a drifting baseline comprising I_{dark} 706. As noted above, I_{dark} 706 is the source-drain current I_{SD} of TFT. In at least one embodiment, I_{dark} 706 may exhibit a drift due to positive bias-induced stress or from illumination-induced stress on IGZO material. In at least one embodiment, gradual drift may be attributed to positive gate-drain bias induced stress or illumination-induced stress. In at least one embodiment, this form of stress may introduce defect states, permitting a baseline dark current drift over a time scale of minutes. Positive bias-induced stress may cause a gradual drift in threshold turn-on voltage Vₜₕ of TFT, so that dark current transfer characteristic shifts along voltage axis, causing a gradual linear reduction in I_{dark} 706.

In some embodiments, Iₚₕ 704 has a duty cycle that illustrates change AI in total current signal 702 when focus position on channel 316 of TFT is alternately illuminated and not illuminated, which is given by equation 1:

ΔI=Iₚₕ=Iₜₒₜ−I_{dark} (1)

In at least one embodiment, ΔI, or Iₚₕ 704, is approximately 20 nA. In at least one embodiment, I_{dark} 706 has a magnitude of approximately 0.75 μA (˜750 nA). In at least one embodiment, I_{dark} 706 exhibits a gradual drift due to positive bias-induced stress, or illumination-induced stress (due to laser). In at least one embodiment, Iₚₕ 704 is approximately 2.5% of magnitude of total current signal 702. In at least one embodiment, magnitude of Iₚₕ 704 is not affected appreciably by baseline slope.

Referring collectively to FIG. 1A and FIG. 7A, in at least one embodiment, total current signal 702 may be modulated during DoS measurement at a much higher frequency than that of the duty cycle. In at least one embodiment, Iₚₕ 704 may be modulated at a frequency of 500 Hz, by pulsing laser light 111 or by optical modulator 120. In at least one embodiment, optical modulator 120 is within an optical path of laser light 111 (FIG. 1A). Other manifestations of optical modulator 120 include electro-optical filters, where intensity of laser beam may be modulated by non-mechanical means using a periodic electrical voltage waveform imposed on electro-optical filter to periodically reduce and increase transparency of an optical aperture or window.

FIG. 7B illustrates plot 700B of photocurrent signal Iₚₕ 704 after lock-in amplification. In at least one embodiment, lock-in amplification may remove baseline slope of I_{dark} 706 as it selects only the component of total signal that varies at same frequency as a reference signal. In at least one embodiment, all higher and lower frequency components, including gradually drifting baseline (e.g., part of 1/f noise), are rejected.

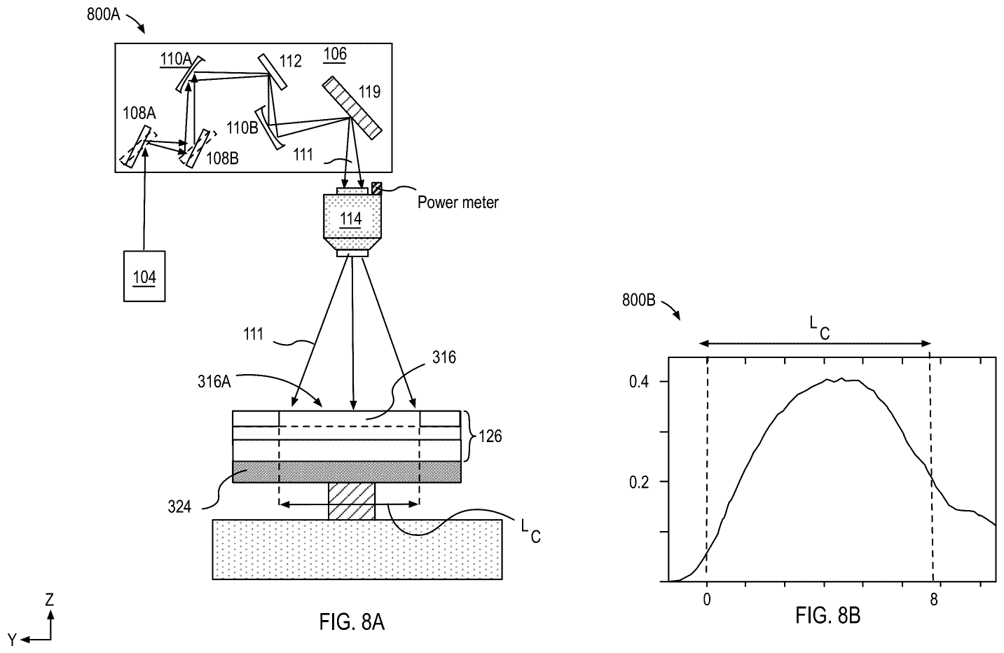

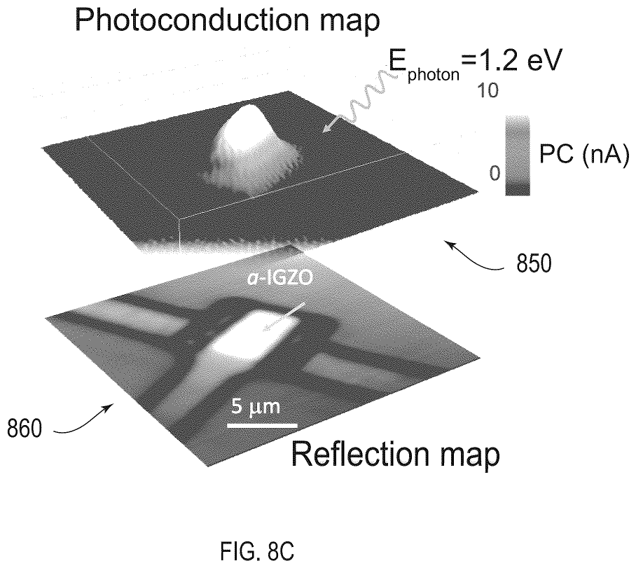

FIG. 8A is a schematic 800A illustrating performance of a laser scan over a surface of channel 316, in at least one embodiment. In at least one embodiment, performing scan includes directing laser light 111 toward reflective laser scanning system 106. In at least one embodiment, the method comprises tilting mirror 108A or mirror 108B to bring about a change in the direction of laser light 111. In at least one embodiment, parabolic reflector 110A and parabolic reflector 110B are fixed, and laser light 111 strikes different parts of surface of parabolic reflector 110A. In at least one embodiment, mirror 108A and mirror 108B are piezo-actuated. In at least one embodiment, mirror 108A and mirror 108B are controllable (e.g., by piezoelectric actuators) to pivot by small fractions of a degree (e.g., millidegrees) to change angle of reflected laser beam also by same or similar fractions of a degree. In at least one embodiment, the reflected laser beam is directed by parabolic reflector 110B to an entrance aperture of reflective objective 114, where it may be focused to a diffraction-limited spot at focal plane. In at least one embodiment, focal plane includes channel 316. In at least one embodiment, focal plane may have a depth of field that encompasses thickness of channel 316.

In at least one embodiment, channel 316 has a thickness of approximately 100 nm. In at least one embodiment, focal plane depth of field is a function of f number of optical system and wavelength of impinging light. Here, the f-number, also described above, is a ratio of focal length of a lens or focusing mirror used for coupling light from one optical component to another, and optical aperture of that lens or focusing mirror. In at least one embodiment, reflective objective 114 may have an f/4 aperture. An f/4 aperture may enable a focal plane depth of field of at least 100 nm, encompassing at least full thickness or channel 316 at all applicable wavelengths. In at least one embodiment, f-number may also partially determine size of a diffraction-limited spot. In at least one embodiment, diffraction limit is also wavelength dependent, as spot size increases with increasing wavelength. In at least one embodiment, other choices of f-number are possible, whereby those f-numbers may also be influenced by geometric factors of optical arrangement as well.

In at least one embodiment, rays of laser light 111 striking different parts of 108A may be all focused at a single point on stationary mirror 112 but reflect off stationary mirror 112 at different angles and strike different parts of parabolic reflector 110B. In at least one embodiment, laser light 111 striking different parts of parabolic reflector 110B are then directed to mirror 119 and enter reflective objective 114 at different angles. In at least one embodiment, laser light 111 may then be directed towards different portions of surface 316A. In at least one embodiment, laser light 111 can be directed from one end of channel 316 to an opposite end of channel 316 to perform a raster scan over a full length of channel L_{C}. In at least one embodiment, scan can be along a single direction on a surface, such as along an x-direction, or along a y-direction in a cartesian coordinate system.

In at least one embodiment, scan can be performed along a combination of both x and y directions. In at least one embodiment, an entire surface 316A can be covered. In at least one embodiment, laser light 111 may be focused onto a spot at each point of surface of channel 316 during raster scan. In at least one embodiment, spot size can be diffraction limited (e.g., 1 micron or more) as noted above. In at least one embodiment, laser raster scans are used to spatially measure defect density of states (DoS), as will be discussed below. In at least one embodiment, a full or a partial raster scan can be performed at a fixed wavelength of tunable laser system 104. In at least one embodiment, once a scan is completed at a given wavelength or energy, a scan at a different energy can be initiated.

FIG. 8B is a plot 800B of photocurrent Iₚₕ 704 versus position on TFT channel at a given laser energy within ultrabroadband photoconduction energy spectrum, in at least one embodiment. Collectively referring to FIG. 8A and FIG. 8B, in at least one embodiment, the scan is performed along a longitudinal line of channel 316 (or along x-direction). In at least one embodiment, semiconductor device 126 shown is biased so that gate-to-source bias is positive 7 volts versus ground. In at least one embodiment, gate to source bias of positive 7 volts places the device in enhancement mode causing dark current to flow in channel 316. In at least one embodiment, when laser light strikes surface 316A, photoexcitation enhances total measured current.

In at least one embodiment, photocurrent Iₚₕ 704 is then extracted from the total current, as discussed above. Plot 800B represents a photocurrent Iₚₕ 704 at a particular photon energy measured along a section line L_{C} of channel 316, extending in an x-direction (arbitrary) for example, where the y-coordinate is held constant. In at least one embodiment, section line L_{C} may extend in an oblique direction, such as along a diagonal, within a predefined raster scan matrix. Photocurrent Iₚₕ 704 is measured at a constant photon energy. In at least one embodiment, photocurrent Iₚₕ 704 has symmetrical characteristics about a mid-point (approximately 4.2 microns from the extremes) along a section L_{C} of channel 316, where peak photocurrent increases to a maximum value, I_{Cmax}, and then decreases towards an edge of channel 316. In at least one embodiment, photocurrent Iₚₕ 704 at edges (or L_{C}=0, and L=L_{C}) are nonzero. In at least one embodiment, photocurrent Iₚₕ 704 at edges are of unequal magnitude.

In at least one embodiment, the energy of tunable laser system 104 can be changed and scan repeated to yield another plot of photocurrent versus position. In at least one embodiment, scan can be shifted to a second line along the longitudinal direction, where the second line is parallel to first line. In this manner, an entire surface of 316A can be mapped.

FIG. 8C illustrates a 3D photoconduction plot 850 taken over an approximately 20 micron×20 micron square region of an integrated circuit comprising an IGZO TFT. The photoconduction data were taken when shining light at a photon energy of 1.2 eV. The data are displayed using a false color scale ranging from 0 (black) to 10 nA (white). The photoconductivity peaks over the center of the scanned region. Positioned below plot 850 is a corresponding reflection map 860, showing that the IGZO TFT is positioned at the center of the scanned region. The position of the IGZO TFT corresponds with the photoconductivity peak in plot 850.

FIG. 9 illustrates an integrated form of a DoS spectral data curve 900. In at least one embodiment, a photocurrent spectrum Iₚₕ(hν) is collected at x, y coordinate on a semiconductor device (e.g., semiconductor device 126), such as TFT. In at least one embodiment, photocurrent spectrum may be obtained at a set gate bias voltage V_{G}. In at least one embodiment, wavelength of emitted light of a source laser (e.g., tunable laser system 104) is tuned across a part or all its spectral range. In at least one embodiment, tunable laser system 104 may be a Ti-sapphire laser having a tunable range of approximately 650 nm to 1100 nm. In at least one embodiment, tunable laser system 104 may be coupled to at least one non-linear optical component, such as an optical parametric oscillator (OPO) and/or a second harmonic generation (SHG) and difference frequency generation (DFG) optical systems (e.g., see Ti-sapphire laser system shown in FIG. 1B).

In at least one embodiment, coupling laser light through non-linear optical components such as those shown in FIG. 1B enables extending laser output to encompass a continuously tunable range of approximately 20,000 nm to 320 nm (e.g., 0.06 eV through 3.9 eV). In at least one embodiment, a laser light spot may be positioned on a particular x, y coordinate on TFT channel region (e.g., channel 316) through a reflective microscope objective (e.g., reflective objective 114) by means of mirror 108A and mirror 108B, as described above. By employment of all-reflective optics, the spot may be focused by reflective objective to a diffraction limited diameter.

In at least one embodiment, a density of states spectrum at any x, y location within a TFT channel region (e.g., channel 316) may be measured by the following procedure. In at least one embodiment, source-drain bias V_{DS} may be set to enable flow of dark—and photocurrent when gate bias V_{GS} is set above (e.g., more positive) threshold voltage (V_{T}) of device. In at least one embodiment, gate bias V_{GS} may be set at a voltage more positive than V_{T} to enable enhancement mode operation of device (e.g., formation of an inversion layer at gate-channel junction to increase conductivity of channel 316). In at least one embodiment, while spot is held at x, y coordinate, laser light may be tuned by adjusting wavelength of output of tunable laser system 104.

The spot may remain in x, y position during the acquisition of photocurrent data within <±0.5 micron due to the precision of actuating system (e.g., piezoelectric) of scanning mirrors (e.g., scanning mirrors 108A and 108B). In at least one embodiment, data may be acquired on a vibration-suppressing table or stage to increase mechanical stability of optical system. In at least one embodiment, the x, y position of the laser spot may be incrementally changed according to a raster scan matrix. In at least one embodiment, photocurrent-spectra may be acquired at each point in raster scan matrix and stored in computer memory.

In at least one embodiment, laser light back-reflected through reflective objective may be collected by a CCD array, for example. Optical data may be employed to create an optical map of the raster portion of TFT channel, such as reflection map shown in FIG. 8C. In at least one embodiment, an optical map may be constructed by assembling optical data at each x, y location within raster scan matrix at a particular photon energy.

In at least one embodiment, TFT drain may collect a total current Iₜₒₜ, which is sum of dark current I_{dark} 706 and a superimposed photocurrent Iₚₕ 704. As noted above, photocurrent Iₚₕ 704 may be a small portion of total current Iₜₒₜ. In at least one embodiment, Iₜₒₜ is routed to an input of a lock-in amplifier (e.g., lock-in amplifier 122), where Iₚₕ 704 is isolated from Iₜₒₜ. In at least one embodiment, Iₚₕ 704 may be several nanoamperes (nA).

Illumination-flux normalized photocurrent spectral data may be converted to densities of intra-bandgap trap states Nₜₒₜ(hν). Referring to FIG. 9, Nₜₒₜ(hν) data are plotted as a function of laser energy (filled dots). Photocurrent Iₚₕ(hν) may be converted to Nₜₒₜ(hν) by following equation:

$${N}_{tot} ( h v ) = Φ ( h v ) \frac{{C}_{ox}}{d} {( \frac{\partial {I}_{D}}{\partial {V}_{G}} )}^{- 1} \frac{{N}_{p h}^{max}}{s} \qquad ( 2 )$$

Where Φ(hν)=Nₑ/Nₚₕ is external quantum efficiency, Nₑ/Nₚₕ is a ratio of electrons liberated per photon, d is thickness of TFT channel region, Cₒₓ is gate oxide capacitance, ∂I_{D}/∂V_{G} is the slope of TFT dark transfer characteristic at the value of V_{g} bias used during the UBPCM measurement. Nₚₕ^{max}/s is the maximum number of photons per second incident on TFT that produces a meaningful increase in photocurrent magnitude, and is used to find an absolute trap density Nₚₕ,^{max}, where photocurrent Iₚₕ 704 saturates when photoexcitation energy hν is close to materials bandgap. Nₚₕ may then be obtained by constructing an incident power calibration curve. This can be done with a power-measuring light sensor (e.g., the power meter shown in FIG. 4) and increasing incident laser photon flux until the photoconduction generated transitions from a linear to a saturation regime.

Equation (2) is a consequence of treating Iₚₕ 704 as result of photofield effect, which causes a shift in V_{T} (ΔV_{T}) when illuminated. An approximation may be employed where ΔV_{T}˜ΔI_{D}(∂I_{D}/∂V_{G})⁻¹. This approximation may be used to extract ΔV_{T} due to laser excitation, by obtaining Iₚₕ=ΔI_{D}.

In at least one embodiment, Nₜₒₜ(hν) may be differentiated (e.g., by numerical differentiation) as a function of photon energy hν to obtain a UBPC DoS spectrum. The experimentally derived DoS spectrum exhibits intra-bandgap density of states spectrum at an x-y position within channel 316 of TFT under study. A full 2D map of DoS over a region of the semiconductor device, such as a defined region within the TFT channel for example, may be obtained by scanning the laser position according to a pre-defined raster pattern to obtain multiple DoS spectra over the defined region within the TFT channel.

FIG. 10 illustrates an exemplary UBPC DoS spectrum 1000 obtained by method described above. In FIG. 10, the UBPC data are presented as a continuous curve 1002 (dashed), representing a trap density Nₜₒₜ continuum within the bandgap of a IGZO TFT. The derived DoS spectrum is shown as DoS peaks 1004, which are obtained by differentiation of curve 1002. The DoS peaks 1004 are delineated by solid lines. The DoS spectrum may be obtained by numerical differentiation of Nₜₒₜ(hν), where DoS˜d(Nₜₒₜ(hν)/d(hν). Here, Nₜₒₜ(hν) is superimposed over the experimentally-derived UBPC DoS peaks to show correspondence between peaks in raw trap data densities Nₜₒₜ(hν) and DoS spectrum. In one example, quasi-linear rise in DoS near valence band edge may be convolved peaks and an Urbach tail DoS. It is noted that an Urbach tail (seen in optical data) is commonly found in amorphous as well as crystalline semiconductors near band edges and is associated with an exponentially increasing envelope of intra-bandgap states near band edges, which are indicated by the dashed vertical lines.

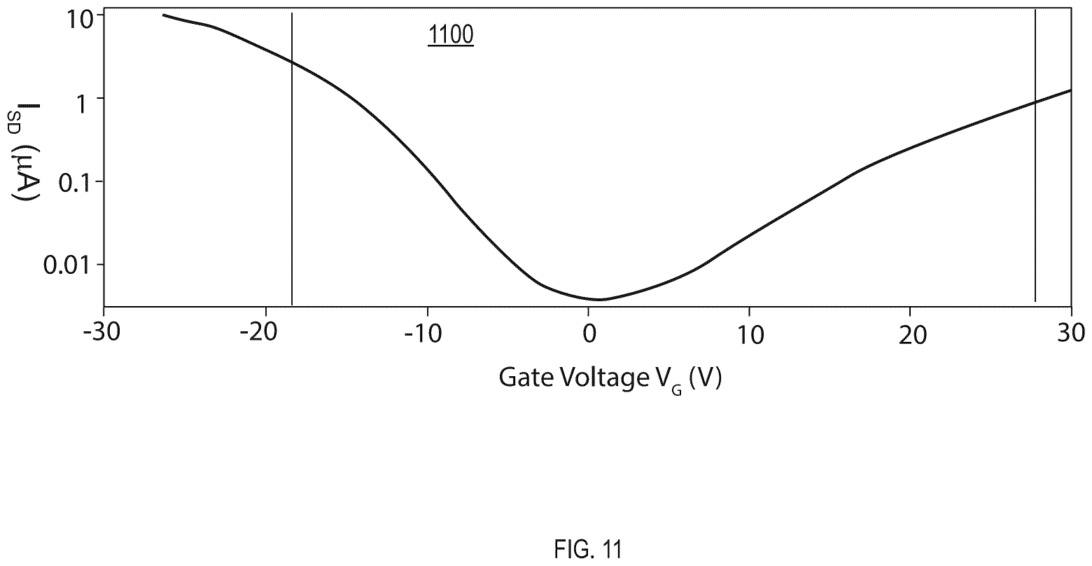

FIG. 11 illustrates a plot 1100 of a gate voltage transfer curve for a tin oxide (SnO) TFT that exhibits ambipolar behavior. In this embodiment, by biasing the applied gate voltage at negative or positive gate voltages, respective P- or N-mode UBPCM measurements of the density of states (DoS) may be made. For example, P-mode biasing enables access to intra-bandgap states close to the conduction band edge, whereas N-mode biasing enables access to intra-bandgap states close to the valence band edge.

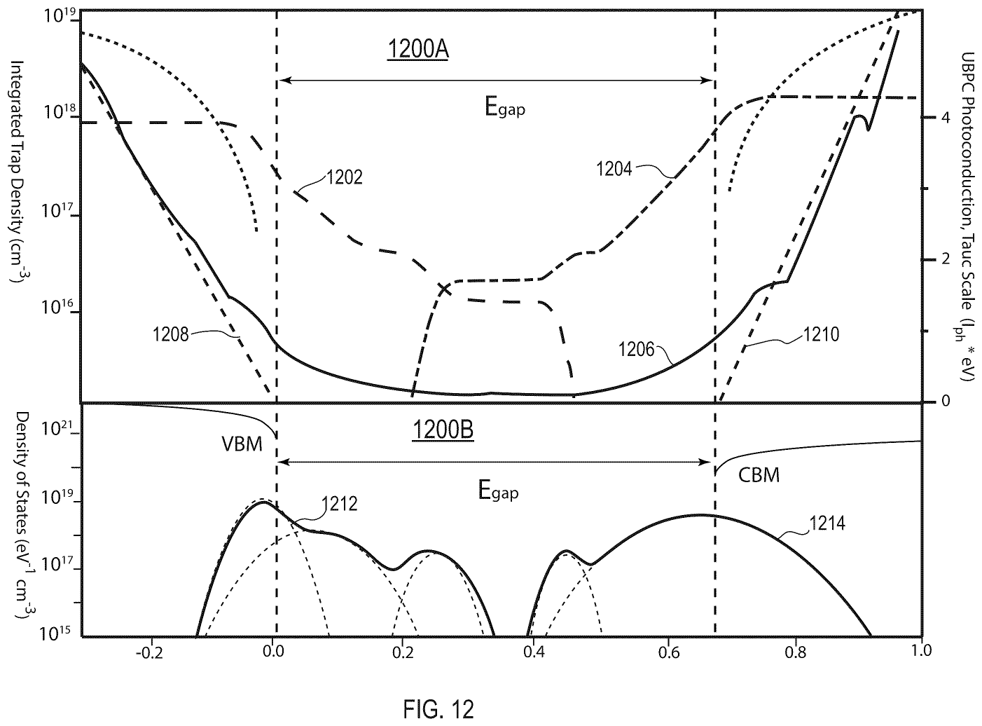

FIG. 12 illustrates a plot 1200A (upper panel) and a plot 1200B (lower panel) of representative UBPCM and DoS measurements, respectively, of an SnO TFT. Plot 1200A displays curve 1202 that traces integrated trap state densities in the lower portion of the bandgap, close to the valence band edge. Here, measurements were taken under an N-mode bias (e.g., Vg>0). For example, the gate voltage Vg is set at +27V for the measurements shown by curve 1202. Curve 1204 traces raw UBPC data as integrated trap state densities in the upper portion of the bandgap, close to the conduction band edge. Here, measurements were taken under P-mode gate voltage, where V_{g}<0. For example, V_{g} is set at −20V for the measurements shown by curve 1204. The raw UBPCM data are plotted on the left axis as integrated trap density. Curve 1206 depicts a Tauc scaling of the raw photoconduction data on the right side of plot 1200A. The Tauc scaling further quantifies the TFT bandgap energy (E_{gap}) by extrapolating the initial slopes of curve 1206 to the x-axis, indicated by the dashed lines 1208 and 1210, where the intercepts of the dashed lines with the x-axis establishes the band edge positions.

Plot 1200B, shown in the lower panel of FIG. 12 shows densities of sub-gap states (DoS) for an SnO TFT, derived from curves 1202 and 1204 by differentiating the trap density (Ntot) data of curves 1202 and 1204. Curve 1212 shows DoS for donor and acceptor trap states near the valence band edge, whereas curve 1214 shows DoS for trap states near the conduction band edge. The dashed curves below the DoS envelopes represent Gaussian fittings to the envelope data to show positions and widths of individual DoS bands.

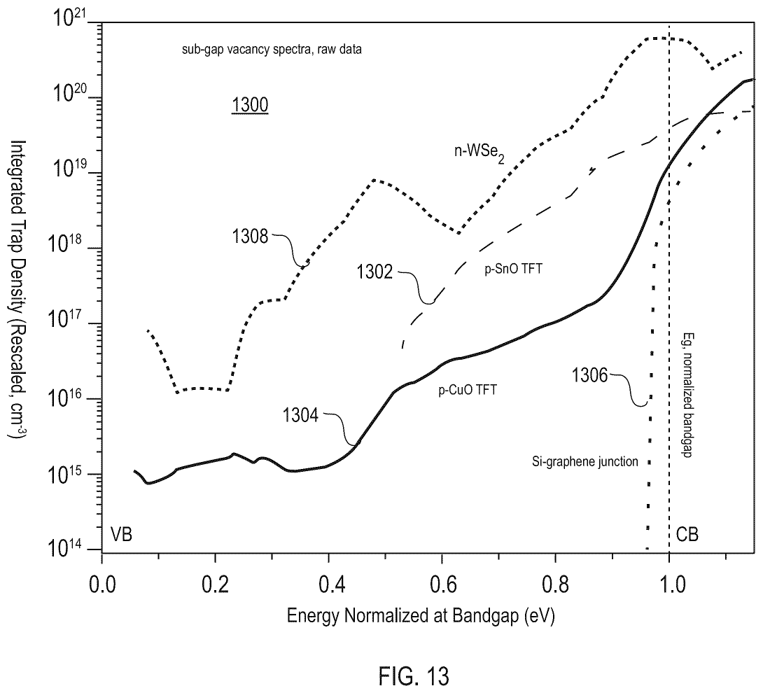

FIG. 13 illustrates a plot 1300 of representative UBPCM measurements for DoS of various semiconductor materials, in accordance with at least one embodiment. The measurements include integrated trap densities plotted as curve 1302 for p-type SnO (stannous oxide thin film MOSFET device), curve 1304 for Cu₂O (cuprous (e.g., copper(I)) oxide thin film MOSFET device), curve 1306 for Si (as a silicon-graphene Schottky-junction device) and curve 1308 for n-type WSe₂ (tungsten diselenide as a thin film MOSFET device, e.g., <100 nm thick). In plot 1300, as the bandgaps of the different semiconductors vary (e.g., E_{g}=0.7 eV for SnO, 1.2 eV (indirect gap) for Cu₂O, ˜1 eV for Si, ˜1.35 eV for WSe₂) bandgaps are normalized to 1.0 eV to directly compare the sub-gap trap densities in terms of positions within the respective bandgaps. On the energy scale axis, the energies range from 0 eV coinciding with the valence band edge, to 1.0 eV, corresponding to the conduction band edge.

Plot 1300 demonstrates the versatility of UBPC microscopy apparatus 100A to measure sub-bandgap DoS for various semiconductors, including n-type and p-type oxides, as well as non-oxide materials such as Si and WSe₂, UBPC microscopy apparatus 100A is also capable of measuring sub-bandgap DoS for III-V and other II-VI compounds.

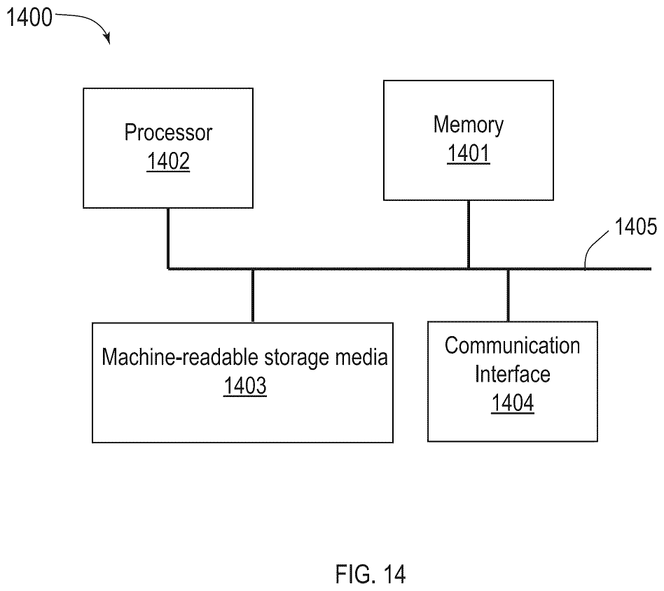

FIG. 14 illustrates a processor system 1400 with a machine-readable storage medium having machine-readable instructions that when executed cause a microcontroller (e.g., processor 1402) in a circuit board of a control unit for scanning UBPC microscopy apparatus 100A to execute machine-readable instructions according to method 200, for example. In at least one embodiment, microcontroller may be configured to measure and report intra-bandgap density of states, in accordance with at least one embodiment. In at least one embodiment, processes described herein may be stored in a machine readable medium (e.g., 1403) as computer-executable instructions. In at least one embodiment, a machine-readable storage medium may be random access memory (RAM), for example. In at least one embodiment, processor system 1400 comprises memory 1401, processor 1402, machine-readable storage medium 1403 (also referred to as tangible machine-readable medium), communication interface 1404 (e.g., wireless or wired interface), and network bus 1405 coupled together as shown.

In at least one embodiment, processor 1402 is a digital signal processor (DSP), an application specific integrated circuit (ASIC), a general-purpose central processing unit (CPU), or a low power logic implementing a simple finite state machine to perform various processes described herein.

In at least one embodiment, various logic blocks of processor system 1400 are coupled together via network bus 1405. Any suitable protocol may be used to implement network bus 1405. In at least one embodiment, machine-readable storage medium 1403 includes instructions (also referred to as program software code/instructions) for measuring voltages and currents, transforming measured voltages and currents and computing temperatures, as described above with reference to various embodiments.

In at least one embodiment, machine-readable storage media 1403 is a machine-readable storage media with instructions for measuring currents and voltages at nodes between components in an UBPC density of states measuring apparatus (e.g., UBPCM apparatus 100A). Machine-readable medium 1403 has machine-readable instructions, that when executed, cause processor 1402 to perform the method discussed herein.

In at least one embodiment, program software code/instructions associated with various embodiments may be implemented as part of an operating system or a specific application, component, program, object, module, routine, or other sequence of instructions or organization of sequences of instructions referred to as “program software code/instructions,” “operating system program software code/instructions,” “application program software code/instructions,” or simply “software” or “firmware” embedded in processor. In some embodiments, program software code/instructions associated with processes of various embodiments are executed by processor system 1400.

In at least one embodiment, machine-readable storage media 1403 is a computer executable storage medium. In at least one embodiment, program software code/instructions associated with various embodiments are stored in computer executable storage medium 1403 and executed by processor 1402. Here, computer executable storage medium 1403 is a tangible machine-readable medium 1403 that can be used to store program software code/instructions and data that, when executed by a computing device, causes one or more processors (e.g., processor 1402) to perform a process.

In at least one embodiment, tangible machine-readable medium 1403 may include storage of executable software program code/instructions and data in various tangible locations, including for example, ROM, volatile RAM, non-volatile memory, and/or cache and/or other tangible memory as referenced in present application. Portions of this program software code/instructions and/or data may be stored in any one of these storage and memory devices. In some embodiments, program software code/instructions can be obtained from other storage, including, for example, through centralized servers or peer-to-peer networks and the like, including Internet. Different portions of software program code/instructions and data can be obtained at different times and in different communication sessions or in same communication session.

In at least one embodiment, software program code/instructions associated with various embodiments can be obtained in their entirety prior to execution of a respective software program or application. Alternatively, portions of software program code/instructions and data can be obtained dynamically, for example, just-in-time, when needed for execution. Alternatively, some combination of these ways of obtaining software program code/instructions and data may occur, for example, for different applications, components, programs, objects, modules, routines, or other sequences of instructions or organization of sequences of instructions, by way of example. Thus, it is not required that data and instructions be on a tangible machine-readable medium 1403 in entirety at a particular instance of time.

In at least one embodiment, tangible machine-readable medium 1403 include but are not limited to recordable and non-recordable type media such as volatile and non-volatile memory devices, read-only memory (ROM), random-access memory (RAM), flash memory devices, floppy and other removable disks, magnetic storage media, optical storage media (e.g., Compact Disk Read-Only Memory (CD ROMs), Digital Versatile Disks (DVDs), etc.), among others. In at least one embodiment, software program code/instructions may be temporarily stored in digital tangible communication links while implementing electrical, optical, acoustical, or other forms of propagating signals, such as carrier waves, infrared signals, digital signals, etc., through such tangible communication links.

In some instances, well-known methods and devices are shown in block diagram form, rather than in detail, to avoid obscuring at least one embodiment. Reference throughout this specification to “an embodiment,” “one embodiment,” “in at least one embodiment,” or “some embodiments” means that a particular feature, structure, function, or characteristic described in connection with embodiment is included in at least one embodiment. Thus, appearances of phrase “in an embodiment,” “in at least one embodiment,” “in one embodiment,” or “some embodiments” in various places throughout this specification are not necessarily referring to same embodiment of disclosure. Furthermore, particular features, structures, functions, or characteristics may be combined in any suitable manner in one or more embodiments. For example, a first embodiment may be combined with a second embodiment anywhere particular features, structures, functions, or characteristics associated with two embodiments are not mutually exclusive.

As used in herein, singular forms “a,” “an,” and “the” are intended to include plural forms as well, unless context clearly indicates otherwise. It will also be understood that term “and/or” as used herein refers to and encompasses all possible combinations of one or more of associated listed items.

Here, “coupled” and “connected,” along with their derivatives, may be used to describe functional or structural relationships between components. These terms are not intended as synonyms for each other. Rather, in particular embodiments, “connected” may be used to indicate that two or more elements are in direct physical, optical, or electrical contact with each other. “Coupled” may be used to indicate that two or more elements are in either direct or indirect (with other intervening elements between them) physical, electrical, or magnetic contact with each other, and/or that two or more elements co-operate or interact with each other (e.g., as in a cause-and-effect relationship).

Here, “over,” “under,” “between,” and “on” refer to a relative position of one component or material with respect to other components or materials where such physical relationships are noteworthy. For example, in context of materials, one material or material disposed over or under another may be directly in contact with, or may have one or more intervening materials. Moreover, one material disposed between two materials may be directly in contact with two layers or may have one or more intervening layers. In contrast, a first material “on” a second material is in direct contact with that second material or materials. Similar distinctions are to be made in context of component assemblies. As used throughout this description, and in claims, a list of items joined by term “at least one of” or “one or more of” can mean any combination of listed terms.

Here, “adjacent” generally refers to a position of a thing being next to (e.g., immediately next to or close to with one or more things between them) or adjoining another thing (e.g., abutting it).

Here, “signal” may refer to current signal, voltage signal, magnetic signal, or data/clock signal.

Here, “device” may generally refer to an apparatus according to context of usage of that term. For example, a device may refer to a stack of layers or structures, a single structure or layer, a connection of various structures having active and/or passive elements, etc. Generally, a device is a three-dimensional structure with a plane along x-y direction and a height along z direction of an x-y-z Cartesian coordinate system. In at least one embodiment, plane of device may also be plane of an apparatus which comprises device.

Unless otherwise specified in explicit context of their use, terms “substantially equal,” “about equal,” and “approximately equal” mean that there is no more than incidental variation between two things so described. Such variation is typically no more than +/−10% of a predetermined target value.

Here, “left,” “right,” “front,” “back,” “top,” “bottom,” “over,” “under,” and similar terms are used for descriptive purposes and not necessarily for describing permanent relative positions. For example, terms “over,” “under,” “front side,” “back side,” “top,” “bottom,” “over,” “under,” and “on” as used herein refer to a relative position of one component, structure, or material with respect to other referenced components, structures, or materials within a device, where such physical relationships are noteworthy. These terms are employed herein for descriptive purposes only and predominantly within context of a device z-axis and therefore may be relative to an orientation of a device. Hence, a first material “over” a second material in context of a figure provided herein may also be “under” the second material if device is oriented upside-down relative to context of figure provided. Similar distinctions are to be made in context of component assemblies.

Here, “between” may be employed in context of z-axis, x-axis, or y-axis of a device. A material that is between two other materials may be in contact with one or both of those materials. In another example, a material that is between two or other material may be separated from both of other two materials by one or more intervening materials. A material “between” two other materials may therefore be in contact with either of other two materials. In another example, a material “between” two other materials may be coupled to two other materials through an intervening material. A device that is between two other devices may be directly connected to one or both of those devices. In another example, a device that is between two other devices may be separated from both of the other two devices by one or more intervening devices.

In at least one example, structures described herein can also be described as method(s) of forming those structures or apparatuses, and method(s) of operation of these structures or apparatuses. The following examples are provided that illustrate at least one example. An example can be combined with any other example. As such, at least one example can be combined with at least another example without changing scope of an example.

Example 1 is an apparatus comprising: a reflective-based microscope with a reflective objective; and a tunable laser system comprising: an all-reflective optical path coupled between the tunable laser system and the reflective microscope objective, wherein the all-reflective optical path comprises: a plurality of scanning mirrors; a first parabolic reflector; and a second parabolic reflector, wherein at least one scanning mirror in the plurality of scanning mirrors is optically coupled between the first parabolic reflector and the second parabolic reflector.

Example 2 is an apparatus according to any example herein, in particular example 1, The apparatus of claim 1, wherein the tunable laser system further comprises a plurality of nonlinear optical components optically coupled to the tunable laser system and a supercontinuum white light laser, and wherein the tunable laser system is operable to produce a first wavelength range of 320 nm to 20000 nm for a continuously tunable spectral output from the tunable laser system.

Example 3 is an apparatus according to any example herein, in particular example 2, wherein the plurality of nonlinear optical components comprise an optical parametric oscillator, a difference frequency generation crystal, and a second harmonic generation crystal, wherein the tunable laser system is optically coupled to the optical parametric oscillator, wherein two spectral output lines of the optical parametric oscillator are optically coupled to the different frequency generation crystal, and a third spectral output line of the optical parametric oscillator is optically coupled to the second harmonic generation crystal.

Example 4 is an apparatus according to any example herein, in particular example 3, wherein the tunable spectral output of the supercontinuum white light laser is coupled into a monochromator, wherein the monochromator is operable to maintain a Poynting vector stability of the supercontinuum white light laser.

Example 5 is an apparatus according to any example herein, in particular example 4, wherein the tunable laser system comprises a plurality of beam splitters and combiners optically coupled to the plurality of nonlinear optical components, and wherein a plurality of spectral input and output lines to and from the plurality of nonlinear optical components are optically combined by the plurality of beam splitters and combiners to produce a second wavelength range between 320 nm and 20,000 nm for the continuously tunable spectral output.

Example 6 is an apparatus according to any example herein, in particular example 1, wherein the first parabolic reflector and a first scanning mirror of the all-reflective optical path is positioned on a first plane, wherein the second parabolic reflector and a second scanning mirror is positioned on a second plane, and wherein the first plane and the second plane are orthogonal to each other.

Example 7 is an apparatus according to any example herein, in particular example 1, further comprising an optical modulator between the tunable laser system and the all-reflective optical path.

Example 8 is an apparatus according to any example herein, in particular example 7, further comprising: a stage; a lock-in amplifier, wherein a first input of the lock-in amplifier is coupled with the optical modulator; and a preamplifier coupled to a second input of the lock-in amplifier, wherein the preamplifier is to be coupled to a terminal of a semiconductor device mounted on the stage and to amplify a current signal from the semiconductor device and convert the current signal to a voltage.

Example 9 is an apparatus according to any example herein, in particular example 7, further comprising a beam splitter between the optical modulator and the all-reflective optical path, wherein the beam splitter is optically coupled to the all-reflective optical path and wherein the beam splitter is optically coupled to a photodetector electrically coupled to a lock-in amplifier.

Example 10 is an apparatus according to any example herein, in particular example 7, further comprising a variable attenuator between the optical modulator and the tunable laser system.

Example 11 is a method of determining a defect density of states in a semiconductor device, the method comprising: loading the semiconductor device into an apparatus, the apparatus comprising: a reflective microscope objective; and a tunable laser system comprising: an all-reflective optical path coupled between the tunable laser system and the reflective microscope objective, wherein the all-reflective optical path comprises: a plurality of scanning mirrors; a first parabolic reflector; and a second parabolic reflector, wherein at least one scanning mirror in the plurality of scanning mirrors is optically coupled between the first parabolic reflector and the second parabolic reflector; and an optical modulator between the tunable laser and the all-reflective optical path; operating the semiconductor device and measuring a current signal at a terminal of the semiconductor device; energizing the tunable laser system and directing a laser beam to a location on a surface of the semiconductor device; generating a photocurrent within the semiconductor device by energizing the tunable laser system; measuring the photocurrent through the terminal of the semiconductor device; utilizing a numerical normalization protocol to obtain a spectrum of an integrated trap density from the photocurrent; and determining the defect density of states based on the spectrum of the integrated trap density.

Example 12 is a method according to any method described herein, in particular example 11, wherein the semiconductor device is a transistor, and wherein operating the transistor to output a steady-state current further comprises adjusting one or more applied voltages to operate the transistor within a linear regime of a transfer characteristic of the transistor.

Example 14 is a method according to any method described herein, in particular example 12, wherein the current signal is a drain current within the linear regime, and wherein the photocurrent is superimposed on a dark current of the transistor.

Example 14 is a method according to any method described herein, in particular example 14, wherein energizing the tunable laser and directing the laser beam comprises performing a raster scan on the surface of a channel material of the transistor to measure the defect density of states (DoS), and wherein performing the raster scan further comprises actuating the first parabolic reflector and the second parabolic reflector in the reflective laser scanning system to direct the laser beam onto a plurality of spots on the surface of the channel material during the raster scan.

Example 15 is a method according to any method described herein, in particular example 14, wherein energizing the tunable laser system comprises changing a photon energy of a light generated by the tunable laser to excite a plurality of electrons from one or more intra-bandgap states within the channel material of the transistor.

Example 16 is a method according to any method described herein, in particular example 15, wherein changing the photon energy of the light generated by the tunable laser comprises operating the tunable laser at a plurality of photon energies ranging between 0.06 eV and 3.5 eV.

Example 17 is a method according to any method described herein, in particular example 16, further comprises holding the plurality of scanning mirrors stationary and continuously varying the photon energy of the tunable laser and measuring the photocurrent at the plurality of photon energies at a constant position on the surface of the channel material.

Example 18 is a method according to any method described herein, in particular example 17, wherein the optical modulator modulates an amplitude of the laser beam at a frequency ranging between 200 Hz and 1 kHz, wherein the photocurrent generated by the semiconductor device is modulated at the frequency of the optical modulator, and wherein the method further comprises: coupling a modulated light signal to a reference input terminal of a lock-in amplifier; and coupling the semiconductor device to a signal input terminal of the lock-in amplifier, wherein the lock-in amplifier outputs a photocurrent signal.

Example 19 is a method according to any method described herein, in particular example 18, wherein the method further comprises implementing a light detector to simultaneously measure a back reflection of the transistor at each laser energy.

Example 20 is a method according to any method described herein, in particular example 19, wherein determining the defect density of states comprises performing a derivative of the photocurrent signal with respect to the photon energy.

Besides what is described herein, various modifications may be made to the disclosed embodiments and implementations thereof without departing from their scope. Therefore, illustrations of embodiments herein should be construed as examples only, and not restrictive to the scope of the present disclosure. The scope of the invention should be measured solely by reference to the claims that follow.

What is claimed is:

1. An apparatus comprising:
a reflective-based microscope with a reflective objective; and
a tunable laser system comprising:
an all-reflective optical path coupled between the tunable laser system and the reflective objective, wherein the all-reflective optical path comprises:
a plurality of scanning mirrors;
a first parabolic reflector; and
a second parabolic reflector, wherein at least one scanning mirror in the plurality of scanning mirrors is optically coupled between the first parabolic reflector and the second parabolic reflector.

2. The apparatus of claim 1, wherein the tunable laser system further comprises a plurality of nonlinear optical components optically coupled to the tunable laser system and a supercontinuum white light laser, and wherein the tunable laser system is operable to produce a first wavelength range of 320 nm to 20000 nm for a continuously tunable spectral output from the tunable laser system.

3. The apparatus of claim 2, wherein the plurality of nonlinear optical components comprise an optical parametric oscillator, a difference frequency generation crystal, and a second harmonic generation crystal, wherein the tunable laser system is optically coupled to the optical parametric oscillator, wherein two spectral output lines of the optical parametric oscillator are optically coupled to the difference frequency generation crystal, and a third spectral output line of the optical parametric oscillator is optically coupled to the second harmonic generation crystal.

4. The apparatus of claim 3, wherein the continuously tunable spectral output of the supercontinuum white light laser is coupled into a monochromator, wherein the monochromator is operable to maintain a Poynting vector stability of the supercontinuum white light laser.

5. The apparatus of claim 4, wherein the tunable laser system comprises a plurality of beam splitters and combiners optically coupled to the plurality of nonlinear optical components, and wherein a plurality of spectral input and output lines to and from the plurality of nonlinear optical components are optically combined by the plurality of beam splitters and combiners to produce a second wavelength range between 320 nm and 20,000 nm (0.12 to 3.90 eV) for the continuously tunable spectral output.

6. The apparatus of claim 1, wherein the first parabolic reflector and a first scanning mirror of the all-reflective optical path is positioned on a first plane, wherein the second parabolic reflector and a second scanning mirror is positioned on a second plane, and wherein the first plane and the second plane are orthogonal to each other.

7. The apparatus of claim 1, further comprising an optical modulator between the tunable laser system and the all-reflective optical path.

8. The apparatus of claim 7, further comprising:
a stage;
a lock-in amplifier, wherein a first input of the lock-in amplifier is coupled with the optical modulator; and
a preamplifier coupled to a second input of the lock-in amplifier, wherein the preamplifier is to be coupled to a terminal of a semiconductor device mounted on the stage and to amplify a current signal from the semiconductor device and convert the current signal to a voltage.

9. The apparatus of claim 7, further comprising a beam splitter between the optical modulator and the all-reflective optical path, wherein the beam splitter is optically coupled to the all-reflective optical path and wherein the beam splitter is optically coupled to a photodetector electrically coupled to a lock-in amplifier.

10. The apparatus of claim 7, further comprising a variable attenuator between the optical modulator and the tunable laser system.

11. A method of determining a defect density of states in a semiconductor device, the method comprising:
loading the semiconductor device into an apparatus, the apparatus comprising:
a reflective microscope objective; and
a tunable laser system comprising;
an all-reflective optical path coupled between the tunable laser system and the reflective microscope objective, wherein the all-reflective optical path comprises:
a plurality of scanning mirrors;
a first parabolic reflector; and
a second parabolic reflector, wherein at least one scanning mirror in the plurality of scanning mirrors is optically coupled between the first parabolic reflector and the second parabolic reflector; and
an optical modulator between the tunable laser system and the all-reflective optical path;
operating the semiconductor device and measuring a current signal at a terminal of the semiconductor device;
energizing the tunable laser system and directing a laser beam to a location on a surface of the semiconductor device;
generating a photocurrent within the semiconductor device by energizing the tunable laser system;
measuring the photocurrent through the terminal of the semiconductor device;
utilizing a numerical normalization protocol to obtain a spectrum of an integrated trap density from the photocurrent; and
determining the defect density of states based on the spectrum of the integrated trap density.

12. The method of claim 11, wherein the semiconductor device is a transistor, and wherein operating the transistor to output a steady-state current further comprises adjusting one or more applied voltages to operate the transistor within a linear regime of a transfer characteristic of the transistor.

13. The method of claim 12, wherein the current signal is a drain current within the linear regime, and wherein the photocurrent is superimposed on a dark current of the transistor.

14. The method of claim 13, wherein energizing the tunable laser system and directing the laser beam comprises performing a raster scan on the surface of a channel material of the transistor to measure the defect density of states (DoS), and wherein performing the raster scan further comprises actuating the first parabolic reflector and the second parabolic reflector to direct the laser beam onto a plurality of spots on the surface of the channel material during the raster scan.

15. The method of claim 14, wherein energizing the tunable laser system comprises changing a photon energy of a light generated by the tunable laser system to excite a plurality of electrons from one or more intra-bandgap states within the channel material of the transistor.

16. The method of claim 15, wherein changing the photon energy of the light generated by the tunable laser system comprises operating the tunable laser system at a plurality of photon energies ranging between 0.06 eV and 3.5 eV.

17. The method of claim 16, further comprises holding the plurality of scanning mirrors stationary and continuously varying the photon energy of the tunable laser system and measuring the photocurrent at the plurality of photon energies at a constant position on the surface of the channel material.

18. The method of claim 17, wherein the optical modulator modulates an amplitude of the laser beam at a frequency ranging between 200 Hz and 1 kHz, wherein the photocurrent generated by the semiconductor device is modulated at the frequency of the optical modulator, and wherein the method further comprises:
coupling a modulated light signal to a reference input terminal of a lock-in amplifier; and
coupling the semiconductor device to a signal input terminal of the lock-in amplifier, wherein the lock-in amplifier outputs a photocurrent signal.

19. The method of claim 18, wherein the method further comprises implementing a light detector to simultaneously measure a back reflection of the transistor at each laser energy.

20. The method of claim 19, wherein determining the defect density of states comprises performing a derivative of the photocurrent signal with respect to the photon energy.
